(19) United States
(12) Patent Application Publication
(10) Pub. No.: US 2026/0340519 A1
(43) Pub. Date: Oct. 29, 2026

(54) METHOD AND SYSTEM FOR DYNAMIC CARPOOL FORMATION

(71) Applicant: Lets Carpool Corp., Wilmington, DE (US)

(72) Inventors: Elisha Aryeh LeVine, Jerusalem (IL); Michael Jonathan Cooper, Passaic, NJ (US); David Alan LeVine, Sarasota, FL (US)

(73) Assignee: Lets Carpool Corp., Wilmington, DE (US)

(21) Appl. No.: 19/187,047

(22) Filed: Apr. 23, 2025

(51) Int. Cl. G06Q 10/02; G06Q 20/36; G06Q 30/0283; G06Q 50/47; H04L 9/40; H04W 4/021; H04W 4/029

(52) U.S. Cl. CPC G06Q 10/02; G06Q 20/36; G06Q 30/0283; G06Q 50/47; H04L 63/0435; H04L 63/08; H04L 63/108; H04W 4/021; H04W 4/029; H04L 2463/082

(57) ABSTRACT

In an embodiment, a method for dynamic carpool formation is disclosed. The method is performed by at least one processor including hardware. The method includes generating, using a hybrid encryption system, an encrypted Quick Response (“QR”) code containing ride metadata. The method further includes validating, using a multi-factor authentication system, a first user and a second user who scan the encrypted QR code. The method further includes forming a temporary ride group connection between the first user and the second user if the first user and the second user have been validated. The method further includes implementing geofencing controls for the first user and the second user, managing ride execution and completion through integration with third-party ride services, and dissolving the temporary ride group connection upon ride completion.

### CROSS REFERENCE TO RELATED APPLICATIONS

The present application is related to the following application, which is incorporated by reference herein in its entirety:
application Ser. No. 19/175,643 entitled “METHOD AND SYSTEM FOR SECURE CARPOOLING WITH DYNAMIC GROUP-BASED MATCHING,” filed Apr. 10, 2025.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

This application relates to the field of transportation management and carpooling, and in particular, methods and systems for creating and managing secure, dynamic carpooling services using encrypted, scannable codes such as Quick Response (“QR”) codes or barcodes.

Since the launch of Uber® in 2009, ride-sharing and carpooling applications have soared in popularity due to the numerous advantages they provide over traditional transportation methods. Ride-sharing applications allow users to request a ride with a few taps on their phone, eliminating the need to hail a taxi or wait at a bus stop. These applications offer door-to-door service, making transportation more convenient, especially in areas with limited public transportation options. In many cases, ride-sharing services are more affordable than traditional transportation methods such as taxis and limousines, particularly for shorter distances. Ride-sharing services can increase mobility for individuals who may not have access to personal vehicles or rely on public transportation, including seniors, people with disabilities, and low-income populations.

Although ride-sharing services like Uber® and Lyft® have revolutionized personal transportation, significant challenges persist in creating truly secure and socially connected carpooling experiences. While these platforms have introduced various safety features and convenience mechanisms, existing ride-sharing and carpooling technologies focus primarily on real-time scheduling, network-wide ride coordination, and algorithm-driven matching. Their fundamental approach to trust and group coordination remains limited.

For example, Uber® and similar on-demand ride-sharing services rely primarily on post-ride, reactive rating systems and basic identity verification. Other safety risks such services present include privacy vulnerabilities in location sharing and tracking. Thus, there is a need for an improved method for secure carpooling that addresses privacy and security concerns while managing dynamic group formation, handling complex payment scenarios, and integrating with corporate systems. The present invention creates a comprehensive solution that addresses the fundamental limitations of existing ride-sharing and carpooling platforms while introducing new capabilities for secure transportation coordination.

### SUMMARY

In an embodiment, non-transitory computer-readable media comprising program code that when executed by a programmable processor causes execution of a method for dynamic carpool formation is disclosed. The computer-readable media comprises computer program code for generating, using a hybrid encryption system, an encrypted Quick Response (“QR”) code containing ride metadata. The computer-readable media further comprises computer program code for validating, using a multi-factor authentication system, a first user and a second user who scan the encrypted QR code. The computer-readable media further comprises computer program code for forming a temporary ride group connection between the first user and the second user if the first user and the second user have been validated, and managing ride execution and completion through integration with third-party ride services.

According to an embodiment, generating the encrypted QR code may comprise encrypting a payload containing ride details using a symmetric encryption algorithm, encrypting a symmetric key using an asymmetric encryption algorithm, and combining the encrypted payload and encrypted symmetric key into a QR code. The encrypted payload may comprise a header section comprising one or more of version information, timestamp data, expiration parameters, and digital signatures. The encrypted payload may further comprise an encrypted payload section comprising one or more of ride details, access control parameters, and payment requirements.

According to an embodiment, the ride metadata may comprise one or more of a unique ride identifier, organizer identification, destination coordinates, temporal validity parameters, maximum user count, and ride-specific access controls. In an embodiment, validating a first user and a second user may comprise verifying authentication credentials of the first user and the second user, checking temporal validity of the encrypted QR code, validating location data of the first user and the second user against geofencing parameters, and confirming eligibility of the first user and the second user based on a presence of a temporary ride group connection.

In an embodiment, the computer-readable media may further comprise computer program code for implementing a time-based expiration system wherein a temporal validity is established for the encrypted QR code and automatically invalidating the encrypted QR code upon one or more of exceeding the temporal validity, reaching a maximum user count, processing a ride cancellation, and detecting a security policy violation. The computer-readable media may further comprise computer program code for implementing one or more security measures comprising preventing duplication of the encrypted QR code, detecting tampering attempts, logging validation attempts, maintaining security audit trails, and implementing rate limiting controls.

According to an embodiment, managing ride execution may comprise automatically booking a ride service for the first user and the second user, providing a real-time status update to the first user and the second user, dynamically estimating a ride fare, tracking a location of the first user and the second user, and predicting an arrival time of the first user and the second user. The computer-readable media may further comprise computer program code for implementing geofencing controls for the first user and the second user and managing temporary trust relationships between the first user and the second user. The computer-readable media may further comprise computer program code for dissolving the temporary ride group connection upon ride completion and maintaining audit trails of the temporary ride group connection.

According to an embodiment, the computer-readable media may further comprise computer code for retrieving, from a user database, data for the first user and the second user, calculating a trust score for the first user and the second user using the data, and determining that the calculated trust score exceeds a minimum threshold value. The trust score may be calculated based on a weighted formula combining one or more trust factors. The computer-readable media may further comprise computer program code for updating the temporary ride group connection to a temporary trust relationship between the first user and the second user if the calculated trust score exceeds the minimum threshold value and automatically revoking the temporary trust relationship if the calculated trust score falls below the minimum threshold value.

According to an embodiment, the computer-readable media may further comprise computer code for calculating, by a payment distribution engine, one or more individual shares of a ride cost, reserving, by the payment distribution engine, funds from a digital wallet of the first user and a digital wallet of the second user, and executing, by the payment distribution engine, automated payment distribution upon ride completion.

In an embodiment, a method for dynamic carpool formation is disclosed. The method is performed by at least one processor comprising hardware. The method comprises generating, using a hybrid encryption system, an encrypted QR code containing ride metadata, and validating, using a multi-factor authentication system, a first user and a second user who scan the encrypted QR code. The method further comprises forming a temporary ride group connection between the first user and the second user if the first user and the second user have been validated. The method further comprises implementing geofencing controls for the first user and the second user, managing ride execution and completion through integration with third-party ride services, and dissolving the temporary ride group connection upon ride completion.

According to an embodiment, generating the encrypted QR code may comprise encrypting a payload containing ride details using a symmetric encryption algorithm, encrypting a symmetric key using an asymmetric encryption algorithm, and combining the encrypted payload and encrypted symmetric key into a QR code. The encrypted payload may comprise a header section comprising one or more of version information, timestamp data, expiration parameters, and digital signatures. The encrypted payload may further comprise an encrypted payload section comprising one or more of ride details, access control parameters, and payment requirements.

In an embodiment, the ride metadata may comprise one or more of a unique ride identifier, organizer identification, destination coordinates, temporal validity parameters, maximum user count, and ride-specific access controls. Validating a first user and a second user may comprise verifying authentication credentials of the first user and the second user, checking temporal validity of the encrypted QR code, validating location data of the first user and the second user against geofencing parameters, and confirming eligibility of the first user and the second user based on a presence of a temporary ride group connection.

According to an embodiment, the method may further comprise implementing a time-based expiration system wherein a temporal validity is established for the encrypted QR code and automatically invalidating the encrypted QR code upon one or more of exceeding the temporal validity, reaching a maximum user count, processing a ride cancellation, and detecting a security policy violation. The method may further comprise implementing one or more security measures comprising preventing duplication of the encrypted QR code, detecting tampering attempts, logging validation attempts, maintaining security audit trails, and implementing rate limiting controls.

In an embodiment, managing ride execution may comprise automatically booking a ride service for the first user and the second user, providing a real-time status update to the first user and the second user, dynamically estimating a ride fare, tracking a location of the first user and the second user, and predicting an arrival time of the first user and the second user. The method may further comprise retrieving, from a user database, data for the first user and the second user, calculating a trust score for the first user and the second user using the retrieved data, and determining that the calculated trust score exceeds a minimum threshold value. The trust score may be calculated based on a weighted formula combining one or more trust factors. The method may further comprise updating the temporary ride group connection to a temporary trust relationship between the first user and the second user if the calculated trust score exceeds the minimum threshold value and automatically revoking the temporary trust relationship if the calculated trust score falls below the minimum threshold value. The one or more trust factors may comprise a trust relationship frequency analysis, temporary ride group connection volatility, and historical verification irregularities.

According to an embodiment, the method may further comprise calculating, by a payment distribution engine, one or more individual shares of a ride cost, reserving, by the payment distribution engine, funds from a digital wallet of the first user and a digital wallet of the second user, and executing, by the payment distribution engine, automated payment distribution upon ride completion.

The foregoing summary is illustrative only and is not intended to be in any way limiting. These and other illustrative embodiments include, without limitation, apparatus, systems, methods and computer-readable storage media. In addition to the illustrative aspects, embodiments, and features described above, further aspects, embodiments, and features will become apparent by reference to the drawings and the following detailed description.

### BRIEF DESCRIPTION OF THE DRAWINGS

The invention is illustrated in the figures of the accompanying drawings which are meant to be exemplary and not limiting, in which like references are intended to refer to like or corresponding parts.

FIG. 1 is a diagram of core system components according to an embodiment.

FIGS. 2A-2C are diagrams of a system architecture according to an embodiment.

FIG. 3 is a flow diagram of an example QR code generation and encryption process according to an embodiment.

FIG. 4 is a diagram of a database architecture according to an embodiment.

FIGS. 5A-5B are diagrams of system authentication and group formation components according to an embodiment.

FIGS. 6A-6B are diagrams of a payment processing architecture according to an embodiment.

FIG. 7 is a flow diagram of an example payment process according to an embodiment.

FIG. 8 is a flow diagram of an example payment process according to an embodiment.

FIGS. 9A-9B are diagrams of a corporate expense integration framework according to an embodiment.

FIG. 10 is a flow diagram of an example integration process according to an embodiment.

FIG. 11 is a flow diagram of an example compliance process according to an embodiment.

FIG. 12 is a flow diagram of an example error process according to an embodiment.

FIG. 13 is a flow diagram of an example state transition process according to an embodiment.

FIG. 14 is a flow diagram of an example payment process according to an embodiment.

FIG. 15 is a flow diagram of an example ride lifecycle management process according to an embodiment.

FIGS. 16A-16C are diagrams of a security architecture according to an embodiment.

FIG. 17 is a flow diagram of an example authentication process of a security workflow according to an embodiment.

FIG. 18 is a flow diagram of an example data protection process of a security workflow according to an embodiment.

FIG. 19 is a flow diagram of an example threat response process of a security workflow according to an embodiment.

FIGS. 20A-20C are diagrams of a mobile application user interface according to an embodiment.

FIG. 21 is a flow diagram of an example ride creation process according to an embodiment.

FIG. 22 is a flow diagram of an example join process according to an embodiment.

FIG. 23 is a flow diagram of an example expense process according to an embodiment.

FIGS. 24A-24C are diagrams of a geofencing and location validation system according to an embodiment.

FIG. 25 is a flow diagram of an example location validation process according to an embodiment.

FIG. 26 is a flow diagram of an example security monitoring process according to an embodiment.

FIG. 27 is a flow diagram of an example compliance management process according to an embodiment.

FIGS. 28A-28B are diagrams of a multi-party payment framework according to an embodiment.

FIG. 29 is a flow diagram of an example payment sequence in a multi-party payment process according to an embodiment.

FIG. 30 is a flow diagram of an example payment sequence in a multi-party payment process according to an embodiment.

FIGS. 31A-31B are diagrams of an expense report generation framework according to an embodiment.

FIG. 32 is a flow diagram of an example expense report generation process according to an embodiment.

FIG. 33 is a flow diagram of an example compliance process of an expense report generation framework according to an embodiment.

FIGS. 34A-34B are diagrams of an international payment processing system according to an embodiment.

FIG. 35 is a flow diagram of an example international payment transaction process according to an embodiment.

FIG. 36 is a flow diagram of an example compliance process of an international payment processing system according to an embodiment.

FIGS. 37A-37B are diagrams of an audit trail and logging framework according to an embodiment.

FIG. 38 is a flow diagram of an example audit trail and logging process according to an embodiment.

FIG. 39 is a flow diagram of an example compliance process of an audit trail and logging framework according to an embodiment.

FIG. 40 is a flow diagram of an example method for dynamic carpool formation according to an embodiment.

### DETAILED DESCRIPTION OF THE INVENTION

Subject matter will now be described more fully hereinafter with reference to the accompanying drawings, which form a part hereof, and which show, by way of illustration, exemplary embodiments in which the invention may be practiced. Subject matter may, however, be embodied in a variety of different forms and, therefore, covered or claimed subject matter is intended to be construed as not being limited to any example embodiments set forth herein; example embodiments are provided merely to be illustrative. It is to be understood that other embodiments may be utilized and structural changes may be made without departing from the scope of the illustrative embodiments. Likewise, a reasonably broad scope for claimed or covered subject matter is intended. Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

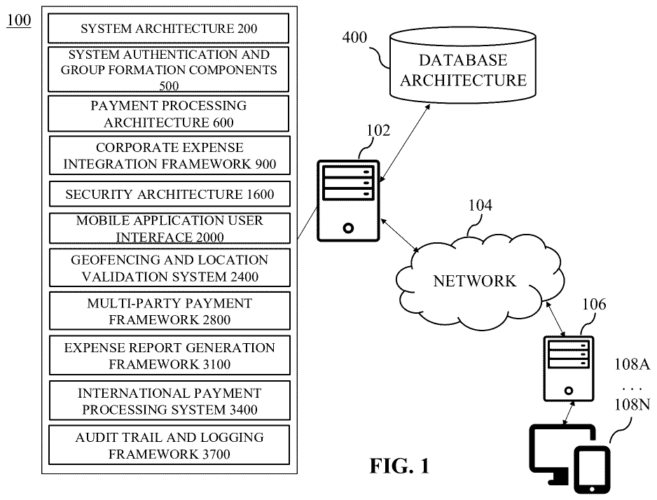

With reference to FIG. 1, a system 100 is disclosed in accordance with embodiments of the invention that implements dynamic carpooling using encrypted QR codes. System 100 comprises a server 102 configured to store system architecture 200, system authentication and group formation components 500, payment processing architecture 600, corporate expense integration framework 900, security architecture 1600, mobile application user interface 2000, geofencing and location validation system 2400, multi-party payment framework 2800, expense report generation framework 3100, international payment processing system 3400, and audit trail and logging framework 3700. Network 104 is configured to connect server 102 with application programming interface (“API”) server 106 to access API connections 108A-108N. System 100 further comprises database architecture 400.

According to an embodiment, system 100 operates through a mobile application interface (i.e., API connections 108A-108N), supported by a secure cloud-based backend infrastructure. In an embodiment, system 100 is accessible on a client device that may comprise computing devices and may vary in terms of capabilities or features, for example, a cell phone, smart phone, tablet computer, laptop, and in-dash car computer, or the like. The client device may be web-enabled and may include one or more physical or virtual keyboards, mass storage, a webcam, a speaker, one or more accelerometers, one or more gyroscopes, global positioning system (GPS) or other location identifying type capability, and a display with a high degree of functionality, such as a touch-sensitive color 2D or 3D display.

The mobile application may comprise native applications including iOS™ (Swift-based implementation), Android™ (Kotlin™-based implementation), and shared business logic using Kotlin Multiplatform™. Key features of the mobile application include background location tracking, push notification system, offline capabilities, and local data encryption.

System 100 is further configured to integrate with existing transportation and carpooling applications and services, including but not limited to, Uber®, Lyft®, Cabify®, Bolt®, and Curb®. According to an embodiment, system 100 is further configured for third-party platform integration including map service integration (e.g., Google Maps® embedding, Waze® navigation integration, Apple Maps® compatibility, and OpenStreetMap® implementation), social platform connectivity (e.g., social media authentication, professional network verification, event platform synchronization, and calendar integration), and enterprise software integration (e.g., HR system connections, corporate directory services, expense management systems, and meeting scheduler integration).

The present invention is configured to function as a mobile application with location-aware services, real-time user interaction, mobile payment processing, and push notification systems. Location-based services of the mobile application comprise geofencing technology, geographic boundary management, location tracking and privacy, and proximity-based matching between users. Security and authentication features of the mobile application include identity verification systems, multi-factor authentication, privacy protection mechanisms, and trust scoring algorithms. The mobile application is further configured for event management utilizing schedule coordination, attendance verification, group transportation planning, and venue-specific logistics. The present invention is further configured for payment processing comprising cost-sharing calculations, group payment management, digital wallet integration, and transaction security.

In an embodiment, mobile platforms may comprise Progressive Web Applications (PWA), native mobile applications, cross-platform frameworks, and hybrid mobile solutions. Enterprise deployments may comprise on-premises installation, cloud-based deployment, hybrid cloud implementation, and edge computing integration.

System 100 is configured to utilize encrypted QR codes to ensure secure, temporary carpool group formation. System 100 combines secure group formation, payment processing, and corporate integration into a cohesive system capable of handling dynamic, real-time carpooling scenarios. System 100 is configured to generate time-sensitive QR codes containing encrypted ride metadata, employing AES-256 for payload security and RSA-2048 for key exchange. System 100 ensures only authorized riders can join a ride using QR-based cryptographic authentication. System 100 encrypts all ride metadata and restricts data visibility to authorized riders. QR validation is restricted based on dynamic geofences, ensuring riders are within a verified pickup zone.

According to an embodiment, a multi-party wallet with escrow functionality automates cost-sharing and integrates with third-party ride services. Ride costs may be determined based on real-time route calculations including distance, time, availability and demand. System 100 is integrated with real-time payment processing, expense management, and dispute resolution capabilities.

According to an embodiment, system 100 flexibly employs NoSQL, SQL, or a combination of both database types for managing user profiles, ride details, and financial transactions, adapting to specific application needs. QR code validation includes geofencing and temporal restrictions to prevent unauthorized access. Corporate expense integration enables automated reporting, cost center allocation, and approval workflows. In an embodiment, QR code configuration employs version 40 QR codes (177×177 modules) for maximum data capacity, error correction level H (30%) for reliability, binary mode for optimal data density, secure metadata embedding in unused error correction areas, and dynamic size adjustment based on payload requirements.

The present invention supports trusted group formations, automated payment splitting, and advanced fraud prevention. Use cases include corporate travel, educational institutions, and carpooling, with security features tailored to each application. For corporate carpooling, employees may securely scan QR codes to join verified company carpools, ensuring automated cost-splitting and fraud prevention. For university campus transport, geofenced QR validation allows students to access campus rides securely without manual approvals. For international travel, blockchain integration enables multi-currency transactions, reducing friction for cross-border carpooling.

System 100 is configured to address technical challenges in temporary group formation, secure data transmission via QR codes, automated multi-party financial transactions, and enterprise system integration. System 100 is configured to manage spontaneous ride-sharing coordination, secure participant authentication, automated cost distribution, and corporate expense reconciliation. The QR codes contemplated herein are configured to be single-use, time-limited, and digitally signed to prevent unauthorized duplication. Geolocation binding ensures only participants within the designated area can scan and activate rides, and AI-driven pattern analysis detects abnormal scanning behaviors, reducing fraud risk.

According to an embodiment, system 100 can alternatively utilize barcode implementations, custom matrix codes, color-enhanced QR codes for increased data capacity, and/or animated QR sequences for enhanced security. In some embodiments, the primary QR-based authentication can be supplemented or replaced by Near Field Communication (NFC) tokens, Bluetooth Low Energy (BLE) beacons, sound-based authentication, and/or biometric verification systems. Each alternative maintains the core principles of secure, time-limited access, real-time validation, encrypted data transmission, and multi-party authentication. Alternative encryption algorithms may comprise ChaCha20 for symmetric encryption, ECC (Elliptic Curve Cryptography) for asymmetric operations, post-quantum cryptography implementations, and hardware-based encryption modules. Key management alternatives may comprise Distributed key management systems Blockchain-based key distribution, Hardware Security Module (HSM) integration, and quantum key distribution readiness.

Security implementation of the encryption architecture may utilize one or more of the following: AES-256 in CBC mode with PKCS7 padding for payload encryption; RSA-2048 for key exchange; SHA-256 for hashing; secure random number generation via hardware RNG; key rotation every 24 hours; and session-specific initialization vectors.

According to an embodiment, system 100 is configured to span multiple technical domains including mobile-based transportation coordination systems, secure QR code generation and validation mechanisms, encrypted group formation and authentication systems, real-time payment processing and escrow systems, corporate expense management and reporting systems, and location-based service integration platforms.

The present invention has broad industrial applicability across multiple sectors, including corporate travel management, education, event logistics, and international mobility. By utilizing encrypted QR codes for dynamic carpool formation and automated payment processing, system 100 addresses key industry challenges such as cost inefficiencies, security vulnerabilities, and administrative overhead.

Corporate travel expense reduction: Organizations that implement system 100 could significantly reduce travel expenses through automated expense reporting, reducing administrative workload; optimized ride-sharing, cutting overall mileage and fuel consumption; elimination of reimbursement errors, minimizing financial discrepancies; and reduced corporate fleet dependency, lowering operational costs.

Projected Example: If a multinational consulting firm were to implement system 100 for inter-city employee travel, it could achieve a 21% reduction in reimbursable travel expenses, potentially saving over $1.2M annually.

Fraud prevention in carpooling and expense reporting: By leveraging AI-driven fraud detection, encrypted QR validation, and geofenced ride authentication, system 100 mitigates common fraudulent activities, including unauthorized ride expense claims, potentially reducing fraudulent reimbursements; fake ride-sharing transactions, lowering ride fraud; and QR code cloning and duplication, prevented through time-sensitive cryptographic validation.

Projected Example: If a corporate ride-hailing service integrated system 100, it could detect and prevent hundreds of fraudulent ride claims annually, reducing financial losses and administrative burden.

University and campus transportation optimization: Universities and educational institutions could benefit by ensuring secure, student-only transport access via identity-bound QR authentication; reducing administrative overhead by automating subsidized transportation management; and enhancing safety through real-time ride tracking and emergency response integration.

Projected Example: A university with 50,000 students implementing system 100 could reduce unauthorized access to campus rides by 73% and increase ride efficiency by 34%.

International travel and compliance: the multi-currency and compliance tracking capabilities of system 100 could improve international travel efficiency by automating tax compliance for global corporate travelers; facilitating cross-border QR validation, ensuring local transportation security; and streamlining VAT processing, reducing compliance errors.

Projected Example: A global corporation adopting this system in multiple regions could reduce cross-border ride expense processing time by 77%, improving compliance tracking and efficiency.

The following terms as used in the description of specific embodiments herein should generally be understood as follows, with variations on that as would be understood by those of skill in the art:

A Quick Response (“QR”) Code generally refers to a two-dimensional barcode that stores data in an encoded format. In the present invention, the QR code contains encrypted ride metadata and time-sensitive access credentials generated via a hybrid encryption system.

A Carpool Organizer generally refers to a user who initiates the creation of a ride-sharing group by generating a secure QR code containing the ride details and access parameters.

A Ride Participant generally refers to a user who joins an existing carpool by scanning the organizer's QR code and undergoing real-time authentication and validation.

A Wallet generally refers to a digital repository linked to a user's account that holds digital currency or tokens used for making ride fare payments. The wallet may support multiple payment methods and is integrated into the multi-party payment processing system.

Escrow generally refers to a temporary holding mechanism within the wallet system used to reserve funds from participants until the completion of the ride, ensuring secure and automated cost distribution.

A Hybrid Encryption System generally refers to a cryptographic approach that combines symmetric and asymmetric encryption techniques. In the present invention, it typically involves 1) encrypting ride metadata with a symmetric algorithm (e.g., AES-256 in CBC mode), and 2) encrypting the symmetric key using an asymmetric algorithm (e.g., RSA-2048). This method secures the data embedded within the QR code.

AES-256 generally refers to a symmetric encryption algorithm that uses a 256-bit key to encrypt data. It is used in the invention to securely encrypt the QR code payload.

RSA-2048 generally refers to an asymmetric encryption algorithm that employs a 2048-bit key for secure key exchange. It is used to encrypt the symmetric AES key that protects the QR code data.

A Digital Signature generally refers to a cryptographic signature created using the signer's private key to verify the integrity and origin of data. Digital signatures are embedded in the QR code to ensure that the data has not been tampered with.

Time-Sensitive QR Codes generally refers to QR codes that include a timestamp and an expiration parameter to ensure that they are valid only for a limited period. This feature prevents unauthorized reuse or replay attacks.

Real-Time Validation generally refers to the immediate verification process that occurs when a QR code is scanned. This process checks the QR code's digital signature, timestamp, geofencing constraints, and other security parameters to confirm its validity at the moment of use.

Geofencing generally refers to a location-based technology that defines virtual boundaries (geofences). Within the present invention, geofencing restricts the scanning and validation of QR codes to specific geographic areas, ensuring that ride authentication occurs only within designated zones.

Multi-Party Payment Processing generally refers to a system for handling payments where multiple users contribute to the ride fare. This system features escrow functionality to securely reserve and later distribute funds among the ride participants.

Trust Scoring generally refers to a metric calculated from historical ride data, user behavior, and other parameters to evaluate the reliability and security of a ride participant. Trust scores may be used to influence authentication and cost-sharing decisions.

Fraud Detection generally refers to techniques and algorithms—often incorporating artificial intelligence and machine learning—that identify and prevent fraudulent activities such as duplicate QR scans, unauthorized access attempts, and collusion among users. According to an embodiment, system 100 implements machine learning models for fraud detection, automated fare calculations, and real-time cost-splitting among riders.

Dynamic Group Formation generally refers to the automated creation of a temporary ride-sharing group based on real-time QR code scanning and validation. This process allows for on-demand and secure carpool formation without prior scheduling.

Microservices Architecture generally refers to a design approach that structures an application as a collection of loosely coupled services, each handling specific functions (e.g., ride management, payment processing, expense integration). This architecture enhances scalability, flexibility, and maintainability. According to an embodiment, system 100 is built on a scalable microservices architecture, implementing load balancing, asynchronous transaction processing, and distributed caching to handle millions of concurrent users. System 100 may support horizontal scaling of all components, auto-scaling based on demand, geographic distribution, load balancing, cache optimization, and connection pooling.

API Integration generally refers to the method by which system 100 communicates with external services (such as third-party ride providers and payment processors) through application programming interfaces (APIs), ensuring secure and seamless data exchange. System 100 is configured to provide API integration for seamless communication with external ride-sharing providers, enabling real-time availability checks to determine the nearest available drivers; fare estimation queries based on distance, demand, and service provider algorithms; ride booking requests to initiate trips directly from the system; and status updates and ride completion notifications ensuring proper validation and financial reconciliation.

A NoSQL Database generally refers to a type of database that stores data in a flexible, schema-less format. In the present invention, NoSQL databases are used to manage unstructured or semi-structured data such as user profiles and ride metadata.

An SQL Database generally refers to a relational database that organizes data into structured tables with defined relationships. SQL databases are employed to maintain transactional data, audit logs, and other structured information.

Blockchain Integration generally refers to the optional incorporation of blockchain technology to enable decentralized payment processing, ensure immutable transaction records, and facilitate secure execution of smart contracts within system 100. According to an embodiment, system 100 integrates blockchain technology for secure, decentralized payment processing and trust scoring, enabling advanced fraud prevention, tamper-proof financial transactions, and real-time transaction tracking. Additionally, smart contracts can be leveraged for automated dispute resolution and escrow services, further enhancing transaction security. In an embodiment, system 100 integrates blockchain technology into the payment processing and wallet system for decentralized payment validation, ensuring tamper-proof transactions; smart contract-based escrow services, enabling automated fund release upon ride completion; immutable transaction records, stored on a distributed ledger for dispute resolution; and cryptocurrency and digital asset support, allowing alternative payment methods beyond traditional banking. Blockchain implementation is designed as an optional security layer, allowing ride service providers or corporate users to enable it based on regulatory and operational requirements. When enabled, blockchain ensures auditability, increased transparency, and fraud resistance without altering core payment processing flows.

Post-Quantum Cryptography generally refers to cryptographic algorithms designed to be secure against potential quantum computer attacks. These may be optionally implemented to enhance long-term data security beyond classical methods such as AES-256 and RSA-2048.

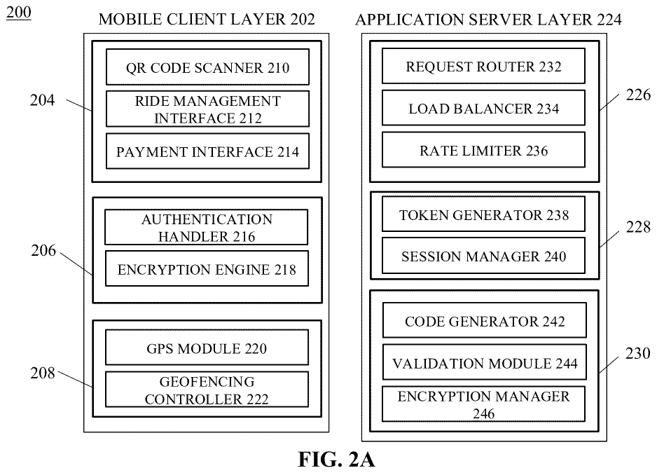

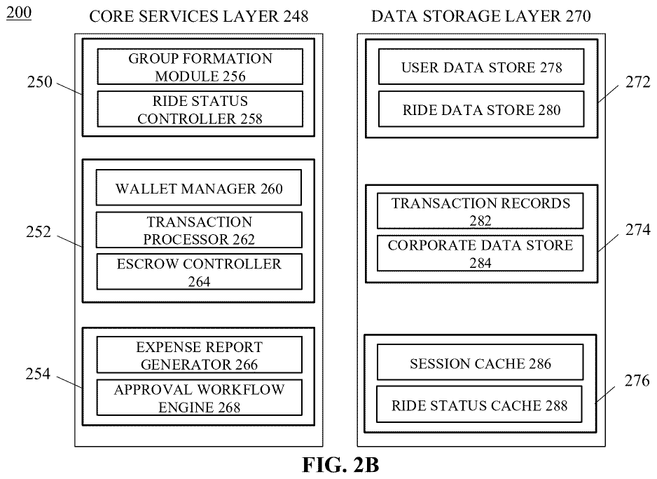

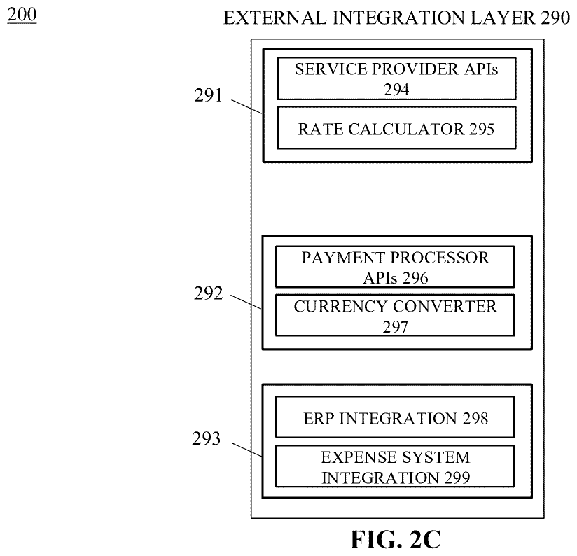

With reference to FIGS. 2A-2C, system architecture 200 is described. System architecture 200 comprises mobile client layer 202l, application server layer 224, core services layer 248, data storage layer 270, and external integration layer 290.

Mobile client layer 202 comprises user interface module 204, local security module 206, and location services 208. User interface module 204 comprises QR code scanner 210, ride management interface 212, and payment interface 214. Local security module 206 comprises authentication handler 216 and encryption engine 218. Location services 208 comprise GPS module 220 and geofencing controller 222.

According to an embodiment, system 100 (via system architecture 200) ensures that only verified ride participants can share location data. System 100 implements QR-validated location sharing, ensuring that only authorized ride participants can track ride status. System 100 requires cryptographic QR validation before sharing ride locations, prevents open-ended user tracking by ensuring real-time ride participation enforcement, and implements encrypted geofenced ride verification to ensure only valid participants access location updates.

Application server layer 224 comprises API gateway 226, authentication server 228, and QR code processing engine 230. API gateway 226 comprises request router 232, load balancer 234, and rate limiter 236. Authentication server 228 comprises token generator 238 and session manager 240. QR code processing engine 230 comprises code generator 242, validation module 244, and encryption manager 246. QR code processing engine 230 is configured to implement hybrid encryption using AES-256 for payload data and RSA-2048 for key exchange. QR code processing engine 230 is further configured to manage QR code lifecycle including generation, validation, and expiration, and to handle real-time authentication and access control.

According to an embodiment, API gateway 226 is configured for an API workflow wherein a user may scan a QR code triggering system 100 to validate and retrieve ride details. System 100 may query third-party ride services for availability and estimated pricing. A ride request may be transmitted via API, including secure token authentication, user location and requested destination, and payment authorization for cost-sharing. System 100 may receive ride confirmation, including an estimated arrival time and driver details, as well as a ride tracking link. Upon ride completion, ride service API may send fare details and system 100 may distribute costs via a multi-party payment processor.

To ensure performance and efficiency at scale, system 100 is configured to implement one or more of the following: horizontal scaling of API gateways, database clusters, and compute nodes; microservices architecture to distribute workload across dedicated service layers; load balancing for API requests to optimize response time; asynchronous processing using event-driven architectures for non-critical operations; and edge computing for QR validation to reduce central server load.

According to an embodiment, projected performance metrics comprise a transaction processing time of <100 ms per validation request; a QR code scan response time of <500 ms, including decryption and ride verification; and concurrent user support of up to 1M active users with auto-scaling mechanisms. System 100 may be optimized to maintain sub-second QR code generation, <3 second validation time, 99.99% system availability. <100 ms transaction processing, real-time group updates, and instant notification delivery. System 100 may implement reliability measures such as multi-region deployment, automatic failover, data replication, transaction redundancy, disaster recovery, and backup systems.

According to an embodiment, system 100 utilizes a microservices architecture deployed on a hybrid cloud infrastructure. Other features of system 100 include a mobile client layer using native iOS/Android applications, application servers on containerized cloud infrastructure, core services distributed across redundant data centers, data storage using hybrid SQL/NoSQL architecture, and external integrations via secure API gateways.

System 100 provides an API integration framework with ride service providers (e.g., real-time availability checking, fare estimation, ride booking and tracking, and status updates) and payment processors (e.g., payment method validation, transaction processing, refund handling, and dispute resolution).

Core services layer 248 comprises ride management service 250, payment processing service 252, and corporate integration service 254. Ride management service 250 comprises group formation module 256 and ride status controller 258. Payment processing service 252 comprises wallet manager 260, transaction processor 262, and escrow controller 264. Corporate integration service 254 comprises expense report generator 266 and approval workflow engine 268.

In an embodiment, enterprise system integration may comprise direct ERP system integration, cloud-based expense management, custom accounting system interfaces, and hybrid deployment models. Compliance frameworks may comprise industry-specific compliance modules, regional regulatory adaptations, custom policy enforcement engines, and automated compliance reporting.

According to an embodiment, ride management service 250 is configured to handle ride lifecycle (e.g., creation and QR code generation, participant joining and validation, ride execution and monitoring, and completion and payment processing) and group management (e.g., temporary group formation, access control and permissions, and real-time participant tracking).

In an embodiment, alternative payment methods may comprise cryptocurrency integration, Central Bank Digital Currencies (CBDCs), closed-loop payment systems, mobile money platforms, and peer-to-peer payment networks. Settlement mechanisms may comprise real-time gross settlement, delayed net settlement, smart contract-based settlement, and cross-border payment networks.

Data storage layer 270 comprises NoSQL database cluster 272, SQL database 274, and cache layer 276. NoSQL database cluster 272 comprises user data store 278 and ride data store 280. SQL database 274 comprises transaction records 282 and corporate data store 284. Cache layer 276 comprises session cache 286 and ride status cache 288.

According to an embodiment, system 100 is configured to employ both NoSQL and SQL databases to optimize different aspects of data management. In one embodiment, system 100 employs both NoSQL and SQL databases; however, the invention may alternatively be implemented using solely NoSQL databases or solely SQL databases without departing from its scope. In an embodiment, database implementations may comprise distributed ledger technology, graph databases, time-series databases, and hybrid storage solutions. Data distribution may comprise edge data storage, distributed caching, content delivery networks, and peer-to-peer storage.

External integration layer 290 comprises ride service connectors 291, payment gateway interface 292, and corporate system connectors 293. Ride service connectors 291 comprises service provider APIs 294 and rate calculator 295. Payment gateway interface 292 comprises payment processor APIs 296 and currency converter 297. Corporate system connectors 293 comprise ERP integration 298 and expense system integration 299.

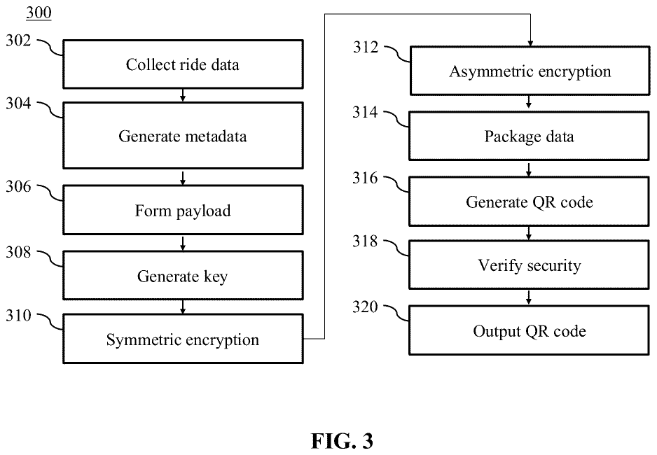

With reference to FIG. 3, a QR code generation and encryption process 300 in accordance with some embodiments will now be described. The process of FIG. 3 comprises steps 302 through 320 and is suitable for use in system 100 but is more generally applicable to other types of carpooling systems.

The input processing stage of process 300 comprises steps 302 through 304. At step 302, ride data, including organizer information, destination coordinates, time parameters, and access control rules, is collected. At step 304, metadata, including unique identifier assignment, timestamp creation, and expiration calculation, is generated. The encryption preparation stage comprises steps 306 through 308. At step 306, a payload, comprising JSON structure creation, data validation, and schema verification, is formed. At step 308, a key, comprising AES-256 key creation, initialization vector generation, and RSA keypair selection, is generated.

The primary encryption stage comprises security-critical operations embodied by steps 310 through 312. At step 310, symmetric encryption is performed, comprising AES-256 CBC mode operation, payload encryption, and MAC generation. At step 312, asymmetric encryption is performed, comprising RSA-2048 implementation, AES key encryption, and digital signature creation. The QR code assembly stage comprises steps 314 through 316. At step 314, data is packaged, the data comprising header formation, encrypted payload integration, and encrypted key attachment. At step 316, a QR code is generated, the QR code comprising format selection, error correction level setting, and size optimization (optional path based on configuration settings). The validation and output stage comprises steps 318 through 320. At step 318 (security-critical operation), security is verified, comprising integrity check, size validation, and format verification (optional path based on configuration settings). At step 320, QR code output is performed, comprising image generation, metadata storage, and distribution preparation.

System 100 leverages AES-256 encryption for payload security and RSA-2048 encryption for key exchange, ensuring ride authentication and fraud prevention at a cryptographic level. System 100 enforces strict cryptographic validation to prevent unauthorized access to rides.

The QR code generation process may implement the following security measures:

Payload Structure:

{
“header”: {
   “version”: “1.0”,
   “timestamp”: “ISO8601_TIMESTAMP”,
   “expiry”: “ISO8601_TIMESTAMP”,
   “signature”: “DIGITAL_SIGNATURE”
},
“payload”: {
   “rideId”: “UNIQUE_IDENTIFIER”,
   “organizerId”: “ORGANIZER_ID”,
   “destination”: {
      “coordinates”: {
         “lat”: “LATITUDE”,
         “lng”: “LONGITUDE”
      }
   }
}

}

Encryption Process: Generate unique AES-256 key for payload encryption; Encrypt payload using AES-256 in CBC mode; Encrypt AES key using recipient's RSA-2048 public key; and Combine encrypted payload and key in QR code.

Key security features implemented in process 300 include separation of symmetric and asymmetric encryption operations, secure key management workflows, multiple validation checkpoints, error handling pathways, and audit logging points. Process 300 ensures that each generated QR code is unique and time-bound, cryptographically secure, efficiently sized for mobile scanning, validated for integrity, and properly logged for audit purposes.

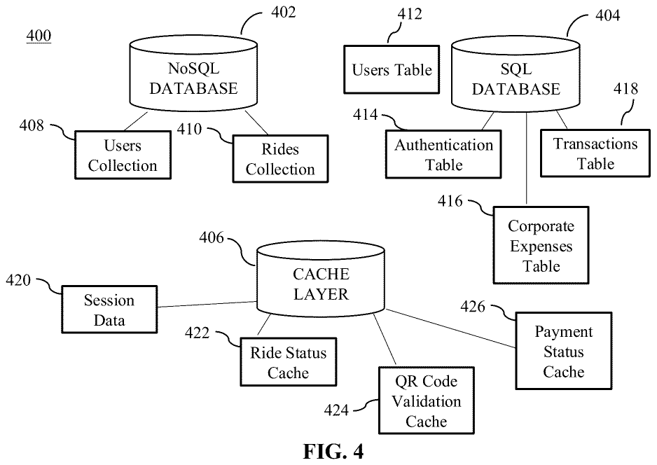

With reference to FIG. 4, a comprehensive database architecture 400 implementing both NoSQL and SQL data structures is disclosed. The illustrated data structures represent one embodiment and are not intended to limit the invention. In some embodiments, various database backends—including exclusively NoSQL or SQL implementations—may be used. Database architecture 400 may implement MongoDB™ for user and ride data, PostgreSQL™ for transaction records, Redis™ for session management, Elasticsearch™ for logging and analytics, and Time-series™ databases for metrics.

NoSQL database 402 comprises users collection 408 and rides collection 410. NoSQL indexes may comprise a user email index, ride status index, QR code token index, and transaction timestamp index.

Users collection 408 may be configured according to the following:

{
“userId”: “UUID”,
“profile”: {
   “name”: “STRING”,
   “email”: “STRING”,
   “phone”: “STRING”,
   “verificationStatus”: “BOOLEAN”,
   “groupMemberships”: [“GROUP_IDS”],
   “corporateProfiles”: [{
      “companyId”: “STRING”,
      “employeeId”: “STRING”,
      “costCenter”: “STRING”,
      “expenseApprovers”: [“USER_IDS”]
   }]
},
“wallet”: {
   “balance”: “DECIMAL”,
   “paymentMethods”: [“PAYMENT_METHOD_IDS”],
   “transactions”: [{
      “id”: “UUID”,
      “type”: “CREDIT/DEBIT”,
      “amount”: “DECIMAL”,
      “timestamp”: “ISO8601”,
      “status”: “STRING”
   }]
},
“securitySettings”: {
   “2faEnabled”: “BOOLEAN”,
   “lastLogin”: “ISO8601”,
   “trustedDevices”: [“DEVICE_IDS”]
}

}

Rides collection 410 may be configured according to the following:

{
“rideId”: “UUID”,
“organizerId”: “USER_ID”,
“status”: “ENUM(PENDING/ACTIVE/COMPLETED)”,
   “qrCode”: {
   “token”: “STRING”,
   “generatedAt”: “ISO8601”,
   “expiryTime”: “ISO8601”,
   “validationRules”: [“RULE_IDS”]
},
“participants”: [{
   “userId”: “USER_ID”,
   “joinTime”: “ISO8601”,
   “status”: “STRING”,
   “paymentStatus”: “STRING”
}],
“rideDetails”: {
   “destination”: {
      “coordinates”: {
         “lat”: “DECIMAL”,
         “lng”: “DECIMAL”
      },
      “address”: “STRING”
   },
   “estimatedCost”: “DECIMAL”,
   “actualCost”: “DECIMAL”,
   “serviceProvider”: “STRING”,
   “tripId”: “STRING”
}

}

SQL database 404 comprises users table 412, authentication table 414, corporate expenses table 416, and transactions table 418. SQL foreign keys may comprise user relationships, transaction chains, and expense linkages.

Users table 412 may be configured according to the following:

CREATE TABLE users (
user_id UUID PRIMARY KEY,
email VARCHAR(255) UNIQUE,
auth_status BOOLEAN,
created_at TIMESTAMP,
last_modified TIMESTAMP

);

Authentication table 414 may be configured according to the following:

CREATE TABLE auth_records (
auth_id UUID PRIMARY KEY,
user_id UUID REFERENCES users(user_id),
auth_type VARCHAR(50),
auth_timestamp TIMESTAMP,
device_info JSONB

);

Corporate expenses table 416 may be configured according to the following:

CREATE TABLE corporate_expenses (
expense_id UUID PRIMARY KEY,
transaction_id UUID REFERENCES transactions(transaction_id),
company_id VARCHAR(255),
cost_center VARCHAR(100),
approval_status VARCHAR(50),
report_id UUID,
submitted_at TIMESTAMP

);

Transactions table 418 may be configured according to the following:

CREATE TABLE transactions (
transaction_id UUID PRIMARY KEY,
ride_id UUID,
payer_id UUID REFERENCES users(user_id),
amount DECIMAL(10,2),
status VARCHAR(50),
created_at TIMESTAMP,
completed_at TIMESTAMP

);

SQL schema may comprise complementary relational tables for user authentication and permissions, transaction history, expense reporting, and corporate integrations.

Cache layer 406 comprises session data 420, ride status cache 422, QR code validation cache 424, and payment status cache 426.

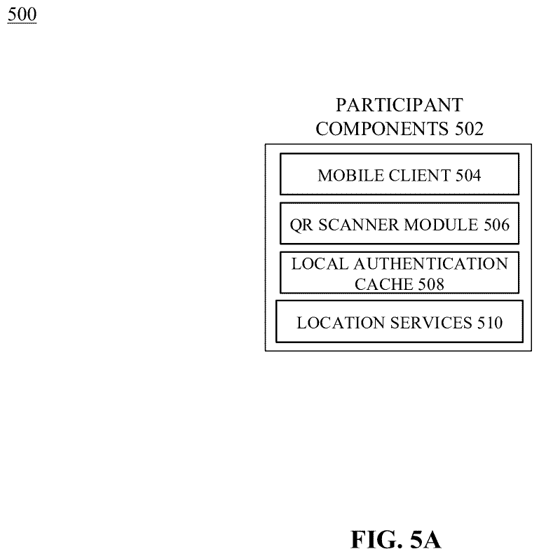

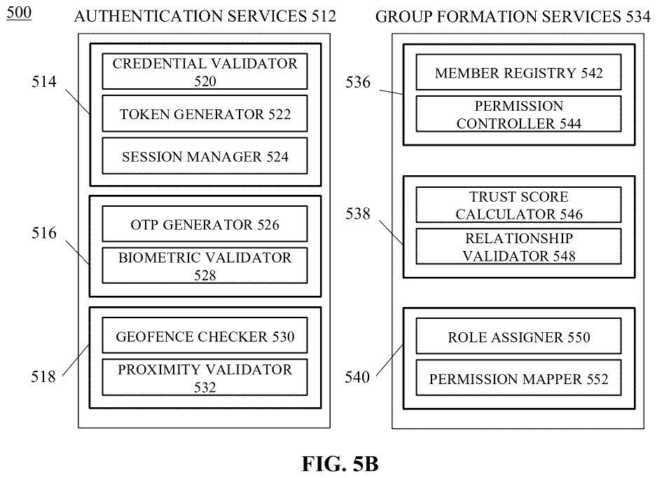

With reference to FIGS. 5A-5B, system authentication and group formation components 500 are disclosed. System authentication and group formation components 500 comprise participant components 502, authentication services 512, and group formation services 534. Participant components 502 include mobile client 504, QR scanner module 506, local authentication cache 508, and location services 510. Group formation may implement two-factor authentication for all participants, real-time digital signature validation, 5-minute maximum QR code validity, concurrent validation of all security parameters, and automatic group dissolution after ride completion.

Authentication services 512 comprise primary authentication server 514, 2FA service 516, and location validator 518. Primary authentication server 514 comprises credential validator 520, token generator 522, and session manager 524. 2FA service 516 comprises OTP generator 526 and biometric validator 528. Location validator 518 comprises geofence checker 530 and proximity validator 532.

Group formation services 534 comprises temporary group manager 536, trust establishment module 538, and access control service 540. Temporary group manager 536 comprises member registry 542 and permission controller 544. Trust establishment module 538 comprises trust score calculator 546 and relationship validator 548. Access control service 540 comprises role assigner 550 and permission mapper 552. According to an embodiment, group formation services 534 may be configured for dynamic group creation (e.g., location-based grouping, event-driven formation, social network integration, and corporate directory integration) and may implement trust models (e.g., reputation-based systems, corporate hierarchy integration, social graph validation, and multi-factor trust scoring).

According to an embodiment, trust score calculation comprises features including dynamic weight adjustment, real-time score updates, fraud detection integration, and audit trail maintenance. Input processing components perform background validation steps for trust score calculation. The output of the trust score calculation comprises an internal security risk assessment, which, according to an embodiment, is for administrative use only. The trust score may range from 0 (indicative of a high or major security risk) to 100 (indicative of a low or non-existent security risk).

In an embodiment, trust score calculator 546 is configured to perform a connection pattern analysis according to the formula (CPA)=(DC×0.6+AB×0.4)×40, wherein DC=Connection creation/deletion frequency and AB=Abnormal behavior patterns. Trust score calculator 546 is further configured to perform a group interaction analysis according to the formula (GIA)=(GM×0.5+GV×0.3+GA×0.2)×30, wherein GM=Group membership volatility, GV=Group violation reports, and GA=Anomalous group activities. Trust score calculator 546 is further configured to perform event behavior monitoring according to the formula (EBM)=(EP×0.4+EI×0.4+EC×0.2×20, wherein EP=Event participation patterns, EI=Incident reports, and EC=Compliance violations. Trust score calculator 546 is further configured to perform historical security analysis according to the formula (HSA)=(VI×0.5+SC×0.3+PR×0.2)×10, wherein VI=Verification irregularities, SC=Security concern reports, and PR=Pattern recognition flags.

The following comprises trust scoring algorithm pseudocode:
function calculateTrustScore(user):
#Connection Pattern Analysis (40% weight) cpa=(connection_freq*0.6+anomaly_score*0.4)*40
#Group Interaction Analysis (30% weight)
gia=(membership_volatility*0.5+violation_reports*0.3+anomalous_activities*0.2)*30
#Event Behavior Monitoring (20% weight)
ebm=(event_participation*0.4+incident_count*0.4+compliance_violations*0.2)*20
#Historical Security Analysis (10% weight)
hsa=(verification_issues*0.5+security_reports*0.3+pattern_flags*0.2)*10
raw_score=cpa+gia+ebm+hsa
return min(100, max(0, raw_score))

According to an embodiment, a trust score is calculated based on established carpooling connections between users which are stored in a connections database. The trust score may be calculated based on a weighted combination of trust factors such as connection frequency analysis, group membership volatility, event participation patterns, and historical verification irregularities. Each of the trust factors may be assigned a relative weight value.

According to some embodiments, connection pattern metrics may be used as inputs to the trust score calculation framework and are continuously updated based on user activity. Connection Frequency (CF) may refer to the number of new connections created or deleted by a user within a rolling 30-day period, normalized against the platform average. Connection Frequency is calculated according to the equation: CF=(user_connections_30d/platform_avg_30d)*100. Abnormal Behavior Score (AB) may refer to the composite score (0-100) calculated from deviations in: Connection acceptance rate; Geographic distribution of connections; Time-of-day connection patterns; and Connection reciprocation rate.

According to some embodiments, group interaction metrics may be used as inputs to the trust score calculation framework and are continuously updated based on user activity. Membership Volatility (MV) may refer to the rate of group joining/leaving within a 90-day period. Membership Volatility is calculated according to the equation: MV=(groups_joined+groups_left)/max_allowed_groups*100. Group Violation Rate (GV) may refer to the weighted sum of reported violations, wherein GV=Σ(violation_severity_weight*violation_count)/time_period. Group Activity Anomaly (GA) may refer to the statistical deviation from expected group participation patterns, wherein GA=|actual_participation−expected_participation|/standard_deviation.

According to some embodiments, event behavior metrics may be used as inputs to the trust score calculation framework and are continuously updated based on user activity. Event Participation (EP) may refer to the ratio of successful event completions, wherein EP=completed_events/total_events*100. Incident Rate (IR) may refer to the weighted frequency of reported incidents, wherein IR=Σ(incident_severity*incident_count)/total_events. Compliance Score (CS) may refer to the percentage adherence to platform rules, wherein CS=(1−(rule_violations/total_actions))*100.

According to some embodiments, historical security measures may be used as inputs to the trust score calculation framework and are continuously updated based on user activity. Verification Index (VI) may refer to the success rate of identity verification attempts, wherein VI=successful_verifications/total_verification_attempts*100. Security Concern Rate (SC) may refer to the frequency of triggered security alerts, wherein SC=security_alerts/total_platform_interactions*100. Pattern Recognition Flag (PR) may refer to binary flags for recognized security patterns, wherein PR=Σ(pattern_weight*pattern_match_boolean).

These terms as used in the description of specific embodiments generally refer to the above definitions, with variations on that as would be understood by those of skill in the art.

In an embodiment, in addition to calculating trust scores for users as passengers, trust score calculator 546 calculates trust scores for users as drivers as well. For example, if a user is designated as a driver, system 100 is configured to evaluate said user's driving-specific behavior. The driver trust score may be calculated using the same, similar, or distinct datapoints, trust factors, and weighted formulas used for passenger trust score calculations. According to an embodiment, a carpooling connection is only established between one or more passengers and a driver once the driver's trust score is validated against a minimum threshold. System 100 may restrict someone from being a driver but may nevertheless allow them to join carpools as a passenger.

According to an embodiment, trust score calculator 546 is configured to evaluate all users—drivers and passengers alike—for safety. System 100 is configured to address the key concern of whether it is safe to be in a car with a given user. The evaluation embodied by the trust score calculation is based on the user's behavior and activity. System 100 is configured to implement further safety features wherein a user may only join a ride if they have an established carpool connection with another user in the ride. A user may also need the driver's approval before joining a carpool if the user is not already directly connected with the driver.

In an embodiment, if a user's trust score falls below a predetermined minimum threshold, the user may lose access to certain features such as the ability to connect with other users, or the ability to form or join carpools with other users. In an embodiment, if a user's trust score falls below an even lower minimum threshold, the user may be placed into a “sandbox,” wherein the user still retains access to system 100 but is unable to connect with or join carpools with any other users. A sandboxed user is essentially invisible to all other users of system 100.

When calculating a trust score, the connection patterns may be assigned, for example, a weight of 0.4. Group behavior monitoring data may be assigned an example weight of 0.3. Event participation analysis data may be assigned an example weight of 0.2. Historical security data may be assigned an example weight of 0.1.

Trust score calculator 546 calculates the trust score, or security risk assessment, by calculating a Raw Risk Score according to the formula CPA+GIA+EBM+HSA. A Normalized Risk Level may then be calculated based on the formula min(100, max(0, Raw Risk Score)).

According to an embodiment, trust score calculator 546 utilizes a weighted scoring algorithm based on factors such as connection history, group participation, and security risk assessment, providing an internal metric for administrative monitoring and threat detection. The security monitoring framework described herein operates as a backend administrative tool. The trust score is used to identify potentially problematic behavior and proactively trigger intervention measures. While it is not displayed to users, the trust score serves as an internal metric to assess the risk level of users and may indirectly influence ride eligibility decisions in certain cases, such as when a user's trust score falls below a critical threshold. This approach balances user privacy with platform security by allowing for intervention in high-risk situations while maintaining a transparent and connection-based carpooling experience.

According to an embodiment, the trust score calculation framework is configured to operate as a backend security tool for identifying potential platform abuse, detecting suspicious behavior patterns, supporting administrative intervention, maintaining platform integrity, and protecting the user community. Key characteristics of the trust score calculation framework include that it is completely invisible to users (with no public scoring or ranking), used solely for security purposes, supports natural connection building, and prevents competitive behavior.

Authentication services 512 are configured for an initial authentication flow of a user (i.e., participant components 502). Mobile client 504 initiates a QR scan by QR scanner module 506, which in turn provides a scan result to mobile client 504. Mobile client 504 conveys an authentication request to primary authentication server 514.

Authentication server 514 sends a check request to local authentication cache 508, which in turn provides a cache status to primary authentication server 514. Authentication server 514 sends a validation request to 2FA service 516, which in turn provides a result of the 2FA validation request to authentication server 514.

Authentication server 514 sends a verification request to location validator 518. Location validator 518 sends a request for location services 510 to get user location data, which location services 510 then provides. Location validator 518 then conveys a determination of location validity to authentication server 514. Authentication server 514 conveys authentication success to mobile client 504, which results in session creation.

Group formation services 534 are configured for a group formation sequence. Following successful user authentication, mobile client 504 sends a group formation request to temporary group manager 536. Temporary group manager 536 sends a request to trust establishment module 538 to validate the user's trust score. Trust establishment module 538 provides a confirmation of validity of the user's trust score to temporary group manager 536.

Temporary group manager 536 requests permissions from access control service 540, which in turn grants permissions. Membership registration is performed by member registry 542. Temporary group manager 536 conveys a completion of group formation and activation to mobile client 504.

Security checkpoints during authentication and group formation include QR code validation (by QR scanner module 506), user identity confirmation (by primary authentication server 514 and 2FA service 516), location verification (by location validator 518), group eligibility check (by temporary group manager 536), and permission assignment (by access control service 540). Key security features implemented by these components include multi-factor authentication steps, real-time location validation, trust score calculation, dynamic permission assignment, and secure session management. The authentication and group formation sequences ensure secure user authentication, proper group membership validation, appropriate permission assignment, complete audit trail creation, and scalable group formation.

System authentication and group formation components 500 are configured to actively restrict QR validation to verified pickup zones, ensuring only authorized users within the location radius can scan and activate a ride. As such, system 100 integrates geofencing with cryptographic QR validation to block unauthorized ride access.

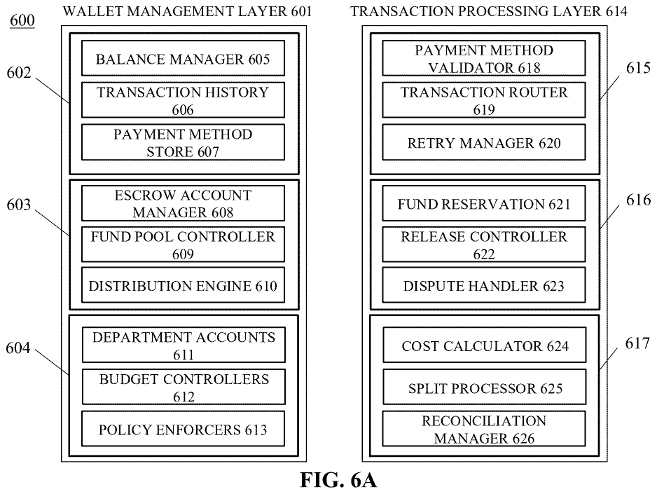

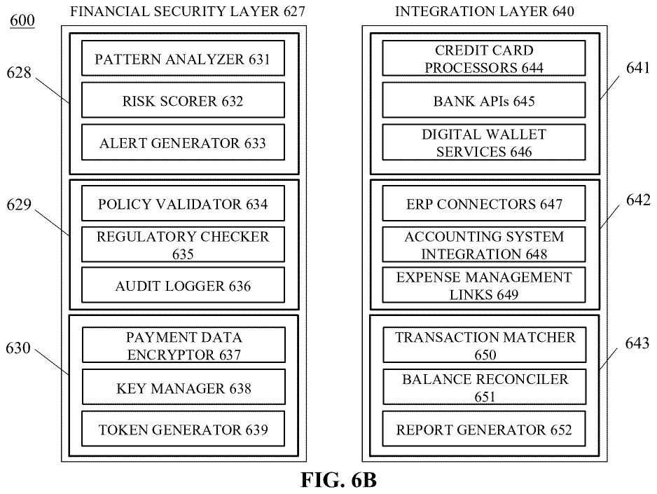

With reference to FIGS. 6A-6B, a payment processing architecture 600 is disclosed. Payment processing architecture 600 comprises wallet management layer 601, transaction processing layer 614, financial security layer 627, and integration layer 640. Payment processing architecture 600 may implement multi-signature escrow accounts, real-time payment authorization, automated cost distribution, instant settlement for domestic transactions, same-day settlement for international transactions, and automated currency conversion at institutional rates.

Wallet management layer 601 comprises individual wallet module 602, group wallet module 603, and corporate wallet module 604. Individual wallet module 602 comprises balance manager 605, transaction history 606, and payment method store 607. Group wallet module 603 comprises escrow account manager 608, fund pool controller 609, and distribution engine 610. Corporate wallet module 604 comprises department accounts 611, budget controllers 612, and policy enforcers 613.

Transaction processing layer 614 comprises payment gateway interface 615, escrow service 616, and settlement engine 617. Payment gateway interface 615 comprises payment method validator 618, transaction router 619, and retry manager 620. Escrow service 616 comprises fund reservation manager 621, release controller 622, and dispute handler 623. Settlement engine 617 comprises cost calculator 624, split processor 625, and reconciliation manager 626.

Financial security layer 627 comprises fraud detection system 628, compliance monitor 629, and encryption service 630. Fraud detection system 628 comprises pattern analyzer 631, risk scorer 632, and alert generator 633. Compliance monitor 629 comprises policy validator 634, regulatory checker 635, and audit logger 636. Encryption service 630 comprises payment data encryptor 637, key manager 638, and token generator 639.

Integration layer 640 comprises payment provider connectors 641, corporate system interface 642, and reconciliation services 643. Payment provider connectors 641 comprises credit card processors 644, bank APIs 645, and digital wallet services 646. Corporate system interface 642 comprises ERP connectors 647, accounting system integration 648, and expense management links 649. Reconciliation services 643 comprise transaction matcher 650, balance reconciler 651, and report generator 652.

Key features of payment processing architecture 600 include real-time balance management, secure payment method storage, multi-party escrow handling, automated distribution logic, dispute resolution pathways, corporate policy enforcement, international payment routing, and audit trail maintenance. Payment processing architecture 600 is configured to implement security measures including end-to-end encryption, tokenization of payment data, multi-factor authorization, real-time fraud detection, and compliance validation.

System 100 is configured to incorporate AI-powered fraud detection and real-time trust scoring models, ensuring ride security through duplicate QR scan prevention to avoid fraudulent ride claims, cost-sharing integrity enforcement, preventing unauthorized fare manipulations, and collusion detection models that track ride-sharing behaviors and flag anomalies. System 100 actively prevents fraud and enforces security compliance at every transaction step. In an embodiment, system 100 employs machine learning algorithms to detect abnormal ride patterns, perform real-time trust scoring, and flag fraudulent transactions before execution.

According to an embodiment, system 100 is configured to use AI and/or machine learning in fraud detection and dynamic pricing. System 100 may leverage artificial intelligence for one or more of the following: (1) Fraud Detection & Trust Scoring: real-time anomaly detection based on ride-sharing patterns. Includes trust scoring model based on historical interactions, user behavior, and network analysis; geolocation-based fraud detection, flagging unusual travel patterns; and social graph validation to detect collusion in fraudulent ride claims. (2) Dynamic Pricing Adjustments, which includes demand-based fare adjustments using time-of-day, location, and ride history; surge prediction models based on traffic and local event data; and AI-driven negotiation models for optimized cost-sharing among users.

According to an embodiment, system 100 may implement a machine learning pipeline wherein: (1) data is ingested and rides and payment events are logged; (2) features are engineered (user behavior, ride metadata, and location trends are extracted); (3) fraud detection and pricing models are trained; and (4) the models apply fraud detection sores and price recommendations at booking to make real-time inferences.

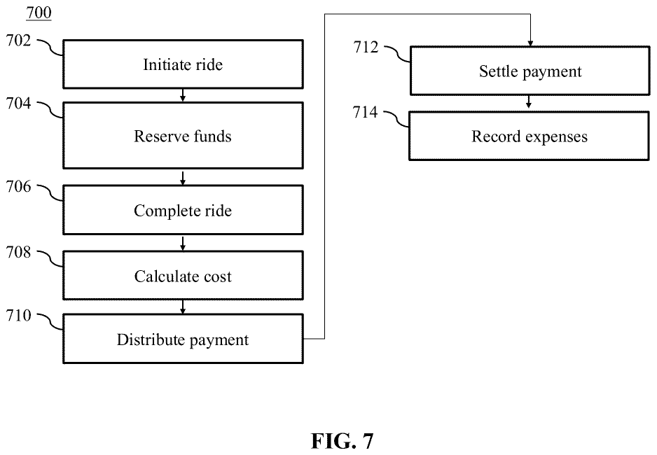

With reference to FIG. 7, a payment process 700 in accordance with some embodiments will now be described. The process of FIG. 7 comprises steps 702 through 714 and is suitable for use in system 100 but is more generally applicable to other types of carpooling systems.

At step 702, a ride is initiated. At step 704, funds are reserved. At step 706, the ride is completed. At step 708, ride costs are calculated. At step 710, payment is distributed amongst the carpooling users. At step 712, payment is settled. At step 714, expenses are recorded.

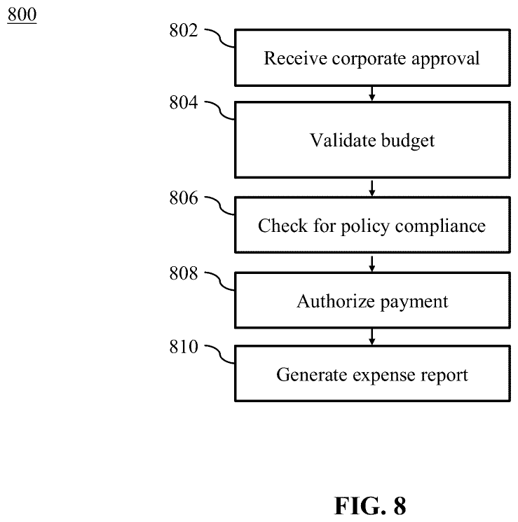

With reference to FIG. 8, a payment process 800 in accordance with some embodiments will now be described. The process of FIG. 8 comprises steps 802 through 810 and is suitable for use in system 100 but is more generally applicable to other types of carpooling systems.

At step 802, corporate approval is received. At step 804, a corporate budget is validated. At step 806, a check for policy compliance is performed. At step 808, payment is authorized. At step 810, an expense report is generated.

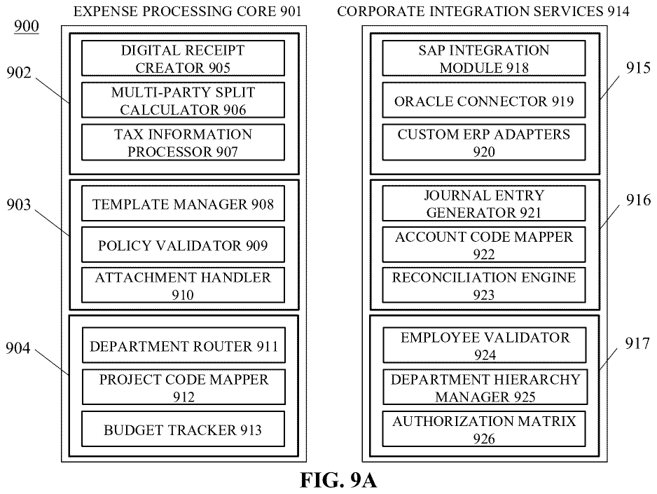

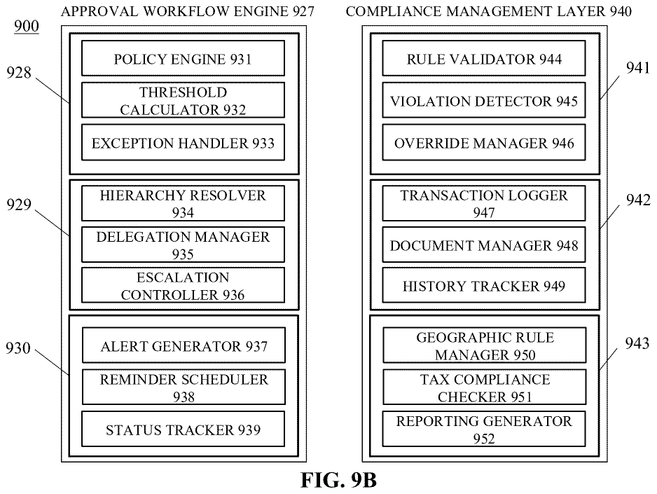

With reference to FIGS. 9A-9B, a corporate expense integration framework 900 is disclosed. Corporate expense integration framework 900 comprises expense processing core 901, corporate integration services 914, approval workflow engine 927, and compliance management layer 940. The expense management system is configured for automated reported (e.g., receipt generation and processing, cost center allocation, approval workflow management, and policy compliance checking) and international support (e.g., multi-currency handling, VAT/Tax processing, cross-border payment management, and regional compliance handling). According to an embodiment, corporate implementation features include direct ERP system integration, real-time policy enforcement, automated approval routing, digital receipt generation, automated expense categorization, and real-time budget tracking.

Expense processing core 901 comprises receipt generation module 902, expense report engine 903, and cost allocation system 904. Receipt generation module 902 comprises digital receipt creator 905, multi-party split calculator 906, and tax information processor 907. Expense report engine 903 comprises template manager 908, policy validator 909, and attachment handler 910. Cost allocation system 904 comprises department router 911, project code mapper 912, and budget tracker 913.

Corporate integration services 914 comprise ERP connector framework 915, accounting system bridge 916, and HR system integration 917. ERP connector framework 915 comprises SAP integration module 918, Oracle connector 919, and custom ERP adapters 920. Accounting system bridge 916 comprises journal entry generator 921, account code mapper 922, and reconciliation engine 923. HR system integration 917 comprises employee validator 924, department hierarchy manager 925, and authorization matrix 926.

Approval workflow engine 927 comprises rule processing unit 928, approver management 929, and notification system 930. Rule processing unit 928 comprises policy engine 931, threshold calculator 932, and exception handler 933. Approver management 929 comprises hierarchy resolver 934, delegation manager 935, and escalation controller 936. Notification system 930 comprises alert generator 937, reminder scheduler 938, and status tracker 939.

Compliance management layer 940 comprises policy enforcement module 941, audit trail system 942, and regulatory compliance engine 943. Policy enforcement module 941 comprises rule validator 944, violation detector 945, and override manager 946. Audit trail system 942 comprises transaction logger 947, document manager 948, and history tracker 949. Regulatory compliance engine 943 comprises geographic rule manager 950, tax compliance checker 951, and reporting generator 952.

According to an embodiment, corporate expense integration framework 900 enables automated expense tracking, cost-center allocation, and approval workflows, ensuring seamless corporate policy compliance and international tax handling. Key features of corporate expense integration framework 900 include automated expense report generation, multi-level approval workflows, real-time policy enforcement, international tax handling, audit trail maintenance, system integration capabilities, compliance monitoring, and exception management. Integration capabilities include ERP system connections, accounting software bridges, HR system integration, tax system linkages, audit tool connections, and reporting system feeds.

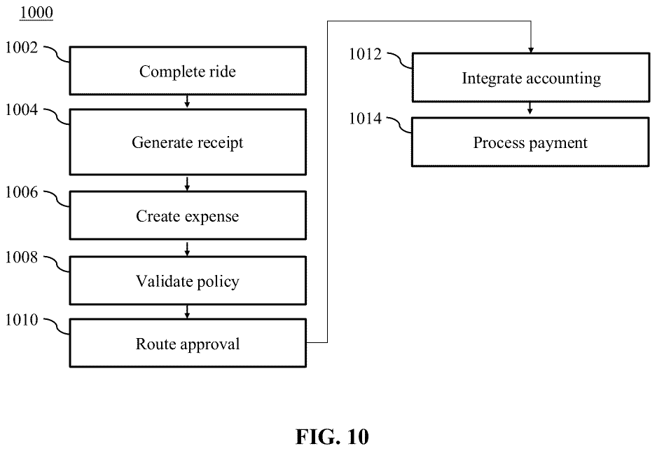

With reference to FIG. 10, an integration process 1000 in accordance with some embodiments will now be described. The process of FIG. 10 comprises steps 1002 through 1014 and is suitable for use in system 100 but is more generally applicable to other types of carpooling systems.

At step 1002, a ride is completed. At step 1004, a receipt is generated. At step 1006, an expense is generated. At step 1008, a policy is validated. At step 1010, a route is approved. At step 1012, accounting is integrated. At step 1014, a payment is processed.

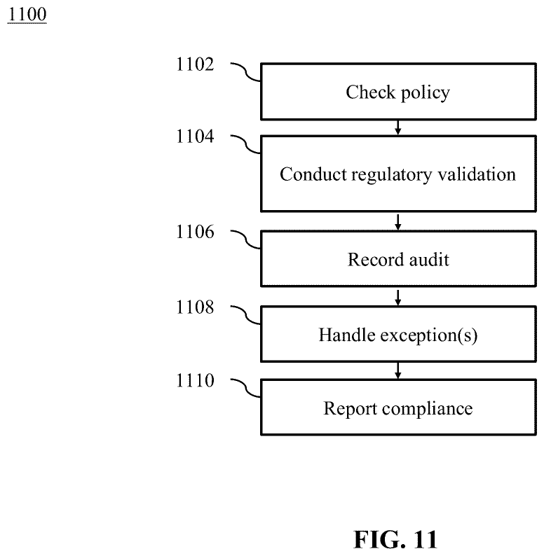

With reference to FIG. 11, a compliance process 1100 in accordance with some embodiments will now be described. The process of FIG. 11 comprises steps 1102 through 1110 and is suitable for use in system 100 but is more generally applicable to other types of carpooling systems.

At step 1102, a corporate policy is checked. At step 1104, regulatory validation is conducted. At step 1106, an audit is recorded. At step 1108, any exceptions are handled. At step 1110, compliance is reported.

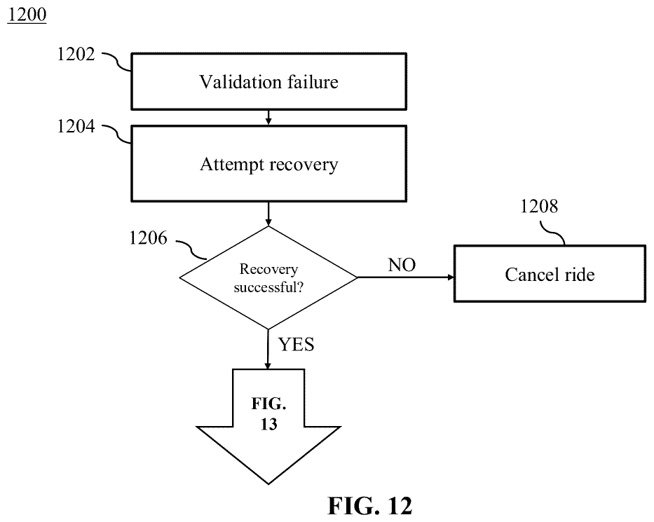

With reference to FIG. 12, an error process 1200 in accordance with some embodiments will now be described. The process of FIG. 12 comprises steps 1202 through 1208 and is suitable for use in system 100 but is more generally applicable to other types of carpooling systems.

The present invention comprises various states, transitions, and associated validation rules for managing a ride lifecycle. Primary states may include initial states (e.g., created, QR generated, pending activation), active states (e.g., group forming, participants joined, ride confirmed), and terminal states (e.g., completed, cancelled, expired). Payment states may include fund verification (e.g., wallet check, escrow pending, funds reserved), transaction states (e.g., payment processing, distribution active, settlement complete), and expense states (e.g., report generated, approval pending, processed).

Transition triggers for transitioning from one state to another state may include user actions (e.g., QR code scan, participant join, organizer confirmation), system events (e.g., time expiration, validation failure, payment completion), and external events (e.g., ride service updates, payment gateway response, corporate approvals). Validation rules may include state entry conditions (e.g., participant requirements, financial prerequisites, temporal constraints) and state exit conditions (e.g., completion criteria, cancellation rules, timeout parameters).

Error handling states may include recovery states (e.g., payment retry, validation retry, group reformation) and fallback states (e.g., graceful degradation, alternative flows, manual intervention).

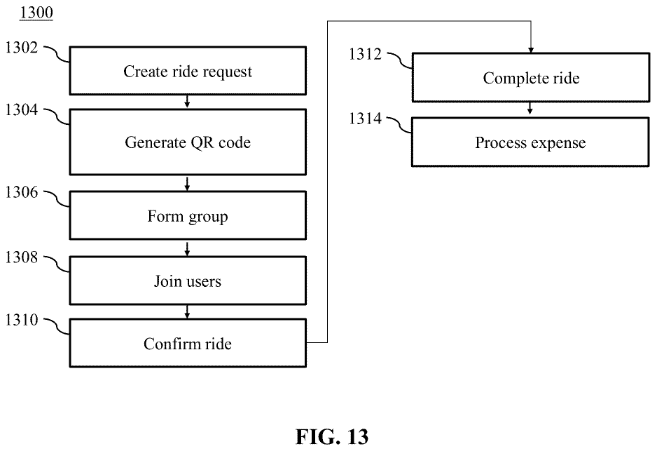

At step 1202, validation is failed. At step 1204, recovery is attempted. At step 1206, a check is performed for whether recovery is successful. If recovery is successful, process 1200 proceeds to process 1300 of FIG. 13. If recovery is not successful, at step 1208, the ride is cancelled.

According to an embodiment, system 100 includes robust mechanisms and fault tolerance measures to prevent and recover from failures. Error handling measures may include redundant failover nodes to ensure high availability, circuit breaker mechanisms to detect API failures and reroute requests, retry logic with exponential backoff for failed transactions, graceful degradation strategies where partial failures do not disrupt ride operations, and automated alerts and monitoring dashboards for real-time anomaly detection.

As part of Distributed State Management, global consistency is maintained through multi-region data replication with configurable consistency levels, distributed cache synchronization using vector clocks, and event-sourced architecture for ride state changes. High availability is ensured via active-active deployment across geographic regions, automatic failover with leader election, and eventual consistency for non-critical operations.

For Load Distribution, request routing is optimized through geographic DNS-based load balancing, session affinity for ride transactions, and distributed rate limiting. Data partitioning strategy comprises sharding by geographic region, hot-spot detection and rebalancing, and cross-partition transaction management. This architecture ensures system reliability under high load while maintaining data consistency for critical operations.

The following are examples of error categories and handling strategies system 100 is configured to implement. QR Code Expiration: User receives real-time warning and can request regeneration. API Timeout with Ride Service: System retries with alternate providers. Payment Processing Failure: System holds the transaction in escrow and notifies users. Network Latency: Local cache validation to enable offline authentication.

With reference to FIG. 13, a state transitions process 1300 in accordance with some embodiments will now be described. The process of FIG. 13 comprises steps 1302 through 1314 and is suitable for use in system 100 but is more generally applicable to other types of carpooling systems.

At step 1302, a ride request is created. At step 1304, a QR code is generated. At step 1306, a group is formed. At step 1308, users are joined to the group. At step 1310, a ride is confirmed. At step 1312, the ride is completed. At step 1314, an expense is processed.

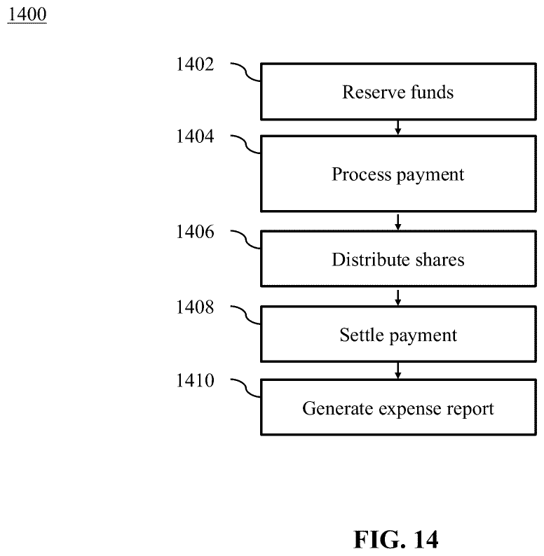

With reference to FIG. 14, a payment process 1400 in accordance with some embodiments will now be described. The process of FIG. 14 comprises steps 1402 through 1410 and is suitable for use in system 100 but is more generally applicable to other types of carpooling systems.

At step 1402, funds are reserved. At step 1404, payment is processed. At step 1406, shares are distributed. At step 1408, payment is settled. At step 1410, an expense report is generated.

The processes of FIGS. 12-14 ensure proper sequence of operations, valid state transitions, complete error handling, payment state tracking, expense report generation, and audit trail maintenance. The processes of FIGS. 12-14 are configured to handle conditions including timeout management, user/participant dropout, payment failures, validation errors, and corporate policy violations.

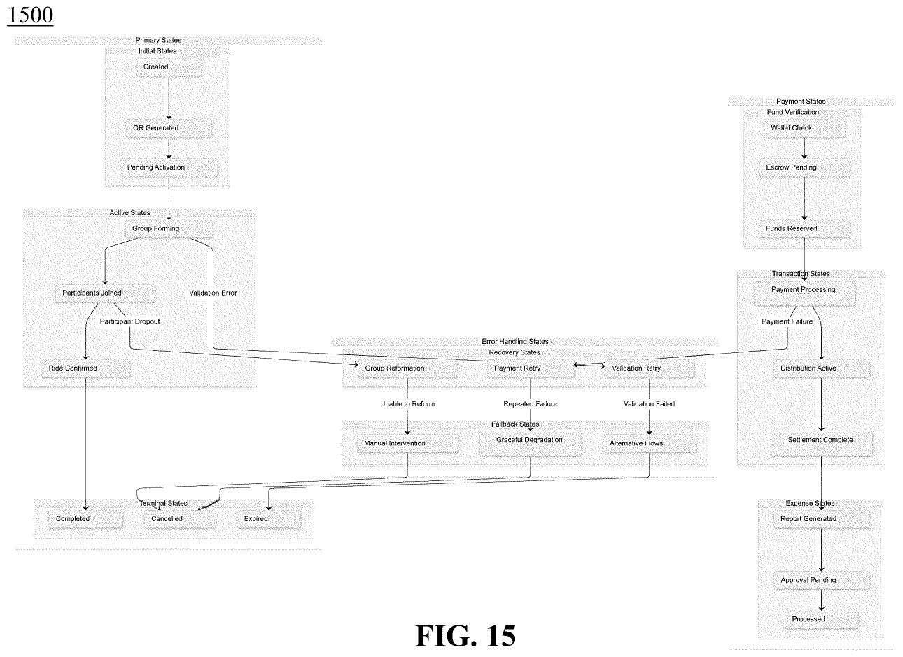

With reference to FIG. 15, a complete state machine 1500 for ride lifecycle management is disclosed. FIG. 15 comprises an example ride lifecycle management process including possible states, transitions, and associated validation rules of system 100.

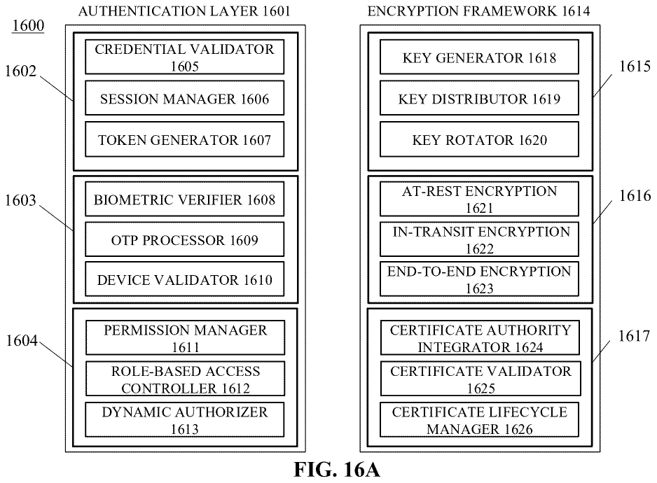

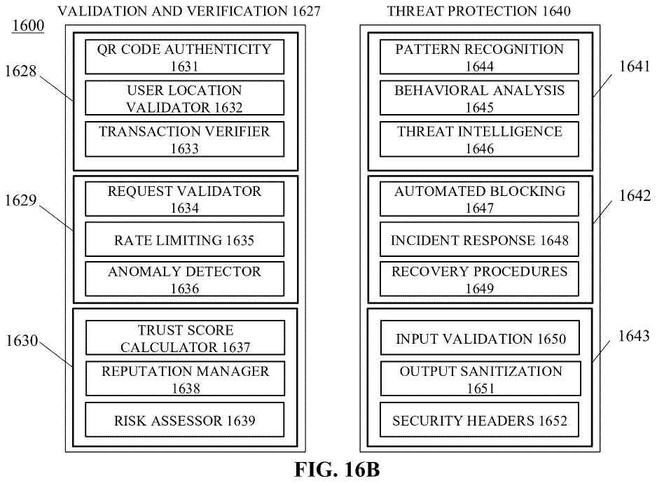

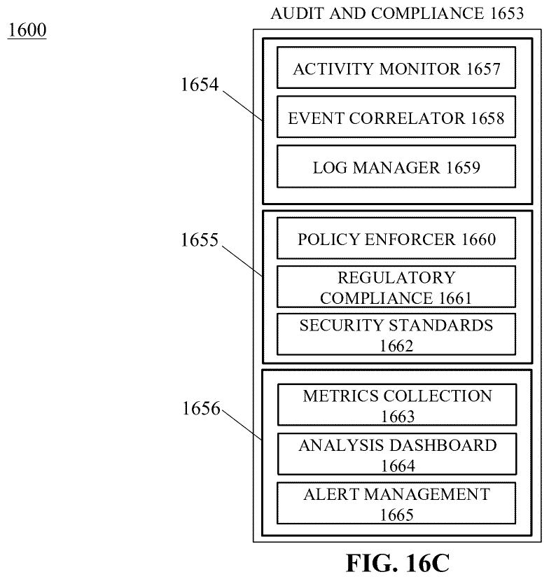

With reference to FIGS. 16A-16C, a comprehensive security architecture 1600 implementing multiple layers of protection, validation, and monitoring is disclosed. Security architecture 1600 is configured with several security features including zero-trust architecture implementation, defense-in-depth strategy, principle of least privilege, security by design, and privacy by default. Security architecture 1600 ensures continuous monitoring for threats, real-time threat detection, automated response capabilities, compliance maintenance, and comprehensive audit trails. Security implementation may comprise multi-factor authentication, real-time threat monitoring, automated incident response, comprehensive audit logging, automated compliance checking, and regular security assessments.

Security architecture 1600 comprises authentication layer 1601, encryption framework 1614, validation and verification layer 1627, threat protection layer 1640, and audit and compliance layer 1653. According to an embodiment, security architecture 1600 may implement authentication methods such as behavioral biometrics, zero-knowledge proofs, decentralized identity, and context-based authentication. Security architecture 1600 may implement audit systems such as Blockchain-based audit trails, distributed logging systems, real-time monitoring, and AI-powered analysis.

Authentication layer 1601 comprises identity manager 1602, multi-factor authenticator 1603, and access controller 1604. Identity manager 1602 comprises credential validator 1605, session manager 1606, and token generator 1607. Multi-factor authenticator 1603 comprises biometric verifier 1608, OTP processor 1609, and device validator 1610. Access controller 1604 comprises permission manager 1611, role-based access controller 1612, and dynamic authorizer 1613.

According to an embodiment, system 100 implements a multi-layer security architecture with user verification (e.g., two-factor authentication for account access, real-time validation of QR code scans, and geofencing controls for location verification) and access control (e.g., role-based permissions system, temporary group membership management, and time-based access restrictions).

Encryption framework 1614 comprises key management system 1615, data protection system 1616, and certificate management system 1617. Key management system 1615 comprises key generator 1618, key distributor 1619, and key rotator 1620. Data protection system 1616 comprises at-rest encryption center 1621, in-transit encryption center 1622, and end-to-end encryption center 1623. Certificate management system 1617 comprises certificate authority integrator 1624, certificate validator 1625, and certificate lifecycle manager 1626.

Validation and verification layer 1627 comprises real-time checks system 1628, security gates 1629, and trust framework 1630. Real-time checks system 1628 comprises QR code authenticity system 1631, user location validator 1632, and transaction verifier 1633. Security gates 1629 comprise request validator 1634, rate limiting system 1635, and anomaly detector 1636. Trust framework 1630 comprises trust score calculator 1637, reputation manager 1638, and risk assessor 1639.

Threat protection layer 1640 comprises detection systems 1641, response mechanisms 1642, and prevention controls 1643. Detection systems 1641 comprise pattern recognition center 1644, behavioral analysis center 1645, and threat intelligence center 1646. Response mechanisms 1642 comprise automated blocking 1647, incident response 1648, and recovery procedures 1649. Prevention controls 1643 comprise input validation 1650, output sanitization 1651, and security headers 1652.

Audit and compliance layer 1653 comprises security logging system 1654, compliance framework 1655, and security reporting system 1656. Security logging system 1654 comprises activity monitor 1657, event correlator 1658, and log manager 1659. Compliance framework 1655 comprises policy enforcer 1660, regulatory compliance 1661, and security standards 1662. Security reporting system 1656 comprises metrics collection 1663, analysis dashboard 1664, and alert management 1665.

According to an embodiment, security architecture 1600 comprises a multi-layered security architecture that ensures data protection, user privacy, and system integrity. Security architecture 1600 is configured to implement the following for data in transit: TLS 1.3 for all network communications, end-to-end encryption for sensitive data, Perfect Forward Secrecy (PFS), certificate pinning for API endpoints, and secure key exchange protocols. Security architecture 1600 is configured to implement the following for data at rest: AES-256 encryption for stored data, encrypted database fields, secure key storage using HSM, regular key rotation, and secure backup encryption.

Security architecture 1600 may implement the following for user authentication: multi-factor authentication, biometric validation options, device fingerprinting, risk-based authentication, and session management. Security architecture 1600 may implement the following for access control: Role-based access control (RBAC), Attribute-based access control (ABAC), just-in-time access provisioning, least privilege principle, and regular access reviews.

Security architecture 1600 may implement the following for QR code generation: time-limited validity, single-use tokens, encrypted payloads, digital signatures, and tamper detection. Security architecture 1600 may implement the following for validation process: real-time verification, geofence validation, device authentication, rate limiting, and replay attack prevention.

Security architecture 1600 may implement the following for transaction protection: tokenized payment information, multi-signature approvals, fraud detection systems, transaction limits, and escrow protection. Security architecture 1600 may implement the following compliance measures: PCI DSS compliance, regional payment regulations, Anti-money laundering (AML), Know Your Customer (KYC), and transaction monitoring.

Security architecture 1600 may implement the following system monitoring features: real-time security monitoring, intrusion detection systems, behavioral analytics, anomaly detection, and performance monitoring. Security architecture 1600 may implement the following audit trails: comprehensive logging, tamper-proof audit logs, access attempt tracking, change management logs, and compliance reporting.

Security architecture 1600 may implement the following data privacy features: data minimization, purpose limitation, privacy by design, consent management, and data anonymization. Security architecture 1600 may implement the following user controls: privacy settings management, data access controls, export capabilities, deletion requests, and usage transparency.

Security architecture 1600 may implement the following detection and analysis measures: automated threat detection, security event correlation, impact assessment, forensic capabilities, and incident classification. Security architecture 1600 may implement the following response and recovery measures: automated response procedures, containment strategies, system recovery processes, incident reporting, and post-incident analysis.

Security architecture 1600 may implement the following network security features: network segmentation, DDoS protection, web application firewall, API gateway security, and regular penetration testing. Security architecture 1600 may implement the following system hardening features: secure configuration, regular patching, vulnerability management, container security, and access control lists.

Security architecture 1600 may implement the following regulatory compliance measures: GDPR compliance, CCPA compliance, industry regulations, regional requirements, and regular audits. Security architecture 1600 may implement the following security policies: security frameworks, policy enforcement, training requirements, documentation, and regular reviews.

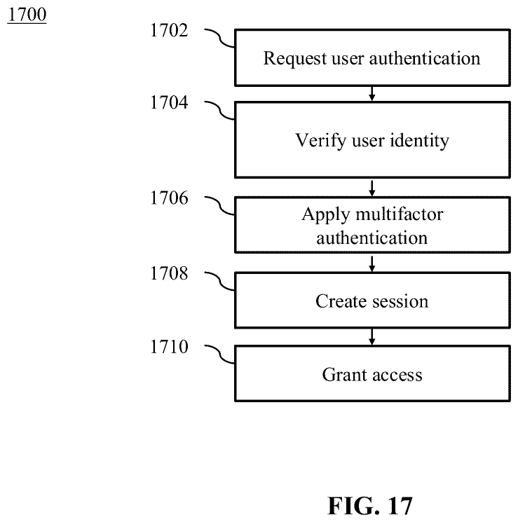

With reference to FIG. 17, an authentication process 1700 of a security workflow i accordance with some embodiments will now be described. The process of FIG. 17 comprises steps 1702 through 1710 and is suitable for use in system 100 but is more generally applicable to other types of carpooling systems.

At step 1702, user authentication is requested. At step 1704, user identity is verified. At step 1706, multi-factor authentication is applied. At step 1708, a session is created. At step 1710, access is granted to the user.

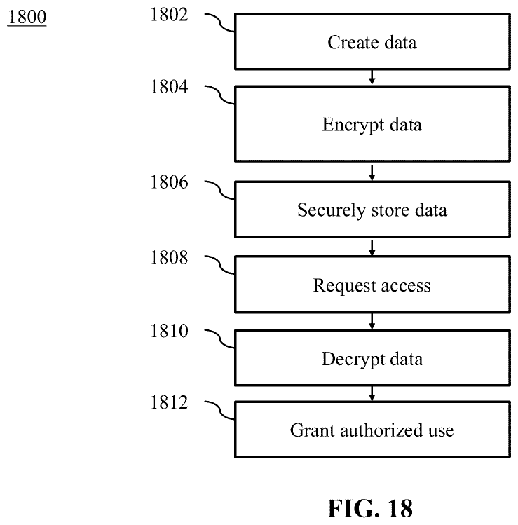

With reference to FIG. 18, a data protection process 1800 of a security workflow in accordance with some embodiments will now be described. The process of FIG. 18 comprises steps 1802 through 1812 and is suitable for use in system 100 but is more generally applicable to other types of carpooling systems.

At steps 1802-1806, data is created, encrypted, and securely stored. At step 1808, access to the data is requested. At step 1810, the data is decrypted. At step 1812, authorized use of the data is granted.

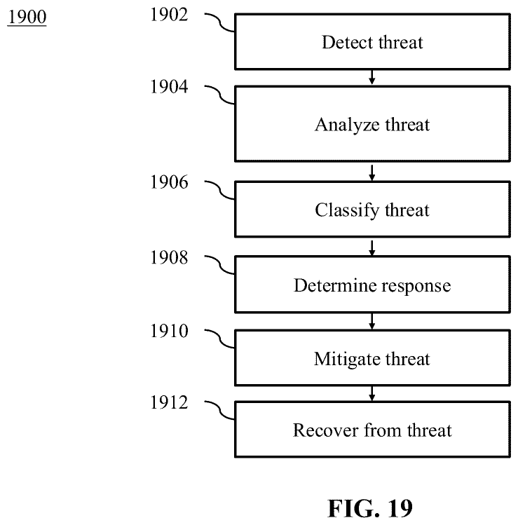

With reference to FIG. 19, a threat response process 1900 of a security workflow in accordance with some embodiments will now be described. The process of FIG. 19 comprises steps 1902 through 1912 and is suitable for use in system 100 but is more generally applicable to other types of carpooling systems.

At steps 1902-1906, a threat is detected, analyzed, and classified. At step 1908, a response to the threat is determined. At step 1910, the threat is mitigated. At step 1912, recovery from the threat is conducted.

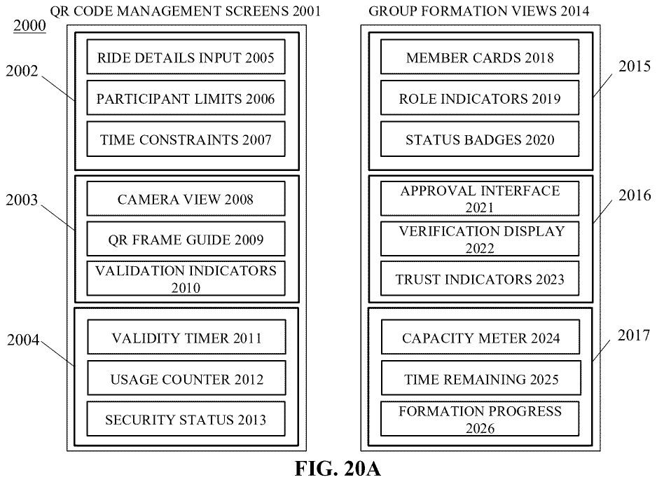

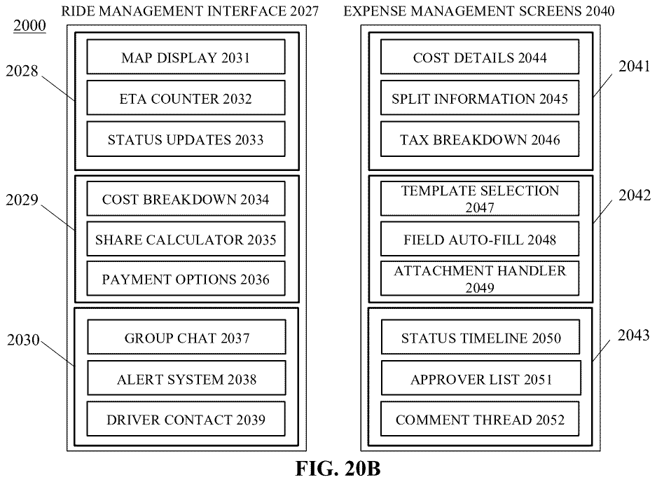

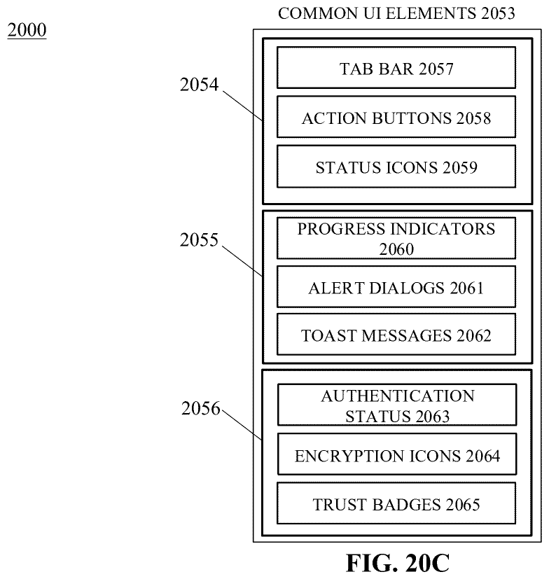

With reference to FIGS. 20A-20C, a mobile application user interface 2000 with certain key screens and user interface components is disclosed. Mobile application user interface 2000 comprises QR code management screens 2001, group formation views 2014, ride management interface 2027, expense management screens 2040, and common UI elements 2053.

QR code management screens 2001 comprise generation interface 2002, scanning interface 2003, and code status display 2004. Generation interface 2002 comprises ride details input 2005, participant limits 2006, and time constraints 2007. Generation interface 2002 may further comprise access rules. Scanning interface 2003 comprises camera view 2008, QR frame guide 2009, and validation indicators 2010. Code status display 2004 comprises validity timer 2011, usage counter 2012, and security status 2013.

Group formation views 2014 comprise participant list 2015, join request handler 2016, and group status panel 2017. Participant list 2015 comprises member cards 2018, role indicators 2019, and status badges 2020. Join request handler 2016 comprises approval interface 2021, verification display 2022, and trust indicators 2023. Group status panel 2017 comprises capacity meter 2024, time remaining 2025, and formation progress 2026.

Ride management interface 2027 comprises active ride view 2028, payment controls 2029, and communication panel 2030. Active ride view 2028 comprises map display 2031, ETA counter 2032, and status updates 2033. Payment controls 2029 comprise cost breakdown 2034, share calculator 2035, and payment options 2036. Communication panel 2030 comprises group chat 2037, alert system 2038, and driver contact 2039.

Expense management screens 2040 comprise receipt generation 2041, report creation 2042, and approval tracking 2043. Receipt generation 2041 comprises cost details 2044, split information 2045, and tax breakdown 2046. Report creation 2042 comprises template selection 2047, field auto-fill 2048, and attachment handler 2049. Approval tracking 2043 comprises status timeline 2050, approver list 2051, and comment threat 2052.

Common UI elements 2053 comprise navigation components 2054, feedback systems 2055, and security indicators 2056. Navigation components 2054 comprise tab bar 2057, action buttons 2058, and status icons 2059. Feedback systems 2055 comprise progress indicators 2060, alert dialogs 2061, and toast messages 2062. Security indicators 2056 comprise authentication status 2063, encryption icons 2064, and trust badges 2065.

User interface includes loading/processing indicators, success confirmations, error notifications, progress tracking, and status updates. User interface ensures intuitive navigation, clear status communication, secure operation indication, real-time updates, and accessibility compliance. User interface may be configured for special features such as dark mode support, offline capabilities, accessibility options, language localization, and emergency controls.

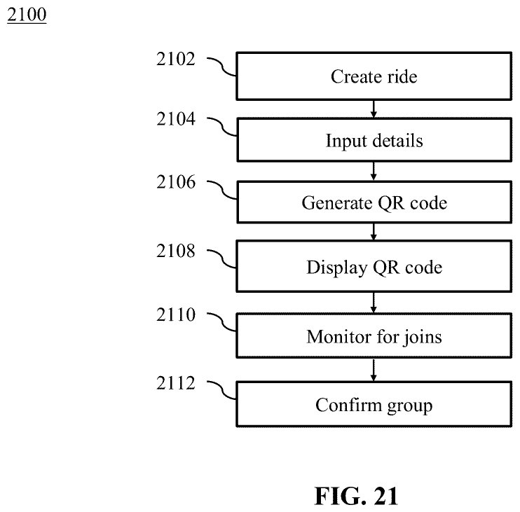

With reference to FIG. 21, a ride creation process 2100 in accordance with some embodiments will now be described. The process of FIG. 21 comprises steps 2102 through 2112 and is suitable for use in system 100 but is more generally applicable to other types of carpooling systems.

At step 2102, a ride is created. At step 2104, details of the ride, including ride metadata, are input. At step 2106, a QR code is generated. At step 2108, the QR code is displayed. At step 2110, system 100 monitors for joins (by users). At step 2110, system 100 confirms a group of users for a carpool.

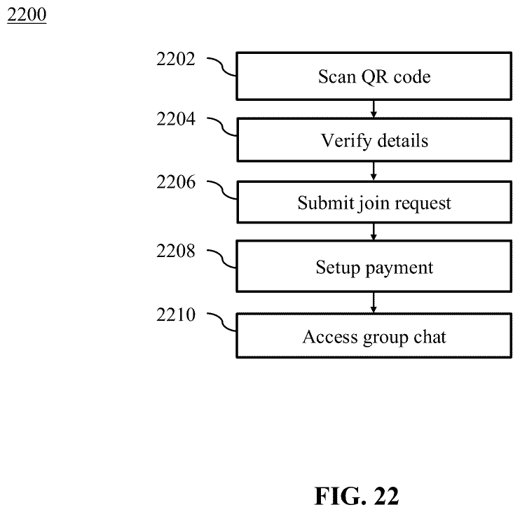

With reference to FIG. 22, a join process 2200 in accordance with some embodiments will now be described. The process of FIG. 22 comprises steps 2202 through 2210 and is suitable for use in system 100 but is more generally applicable to other types of carpooling systems.

At step 2202, a QR code is scanned. At step 2204, ride details are verified. At step 2206, a user submits a join request. At step 2208, payment is set up. At step 2210, the user is granted access to a group chat for the carpool.

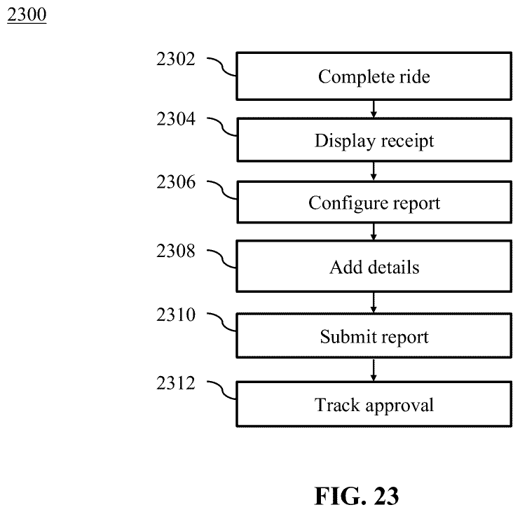

With reference to FIG. 23, an expense process 2300 in accordance with some embodiments will now be described. The process of FIG. 23 comprises steps 2302 through 2312 and is suitable for use in system 100 but is more generally applicable to other types of carpooling systems.

At step 2302, a ride is completed. At step 2304, a receipt is displayed. At step 2306, a report is configured. At step 2308, ride details are added to the report. At step 2310, the report is submitted. At step 2312, approval of the report is tracked.

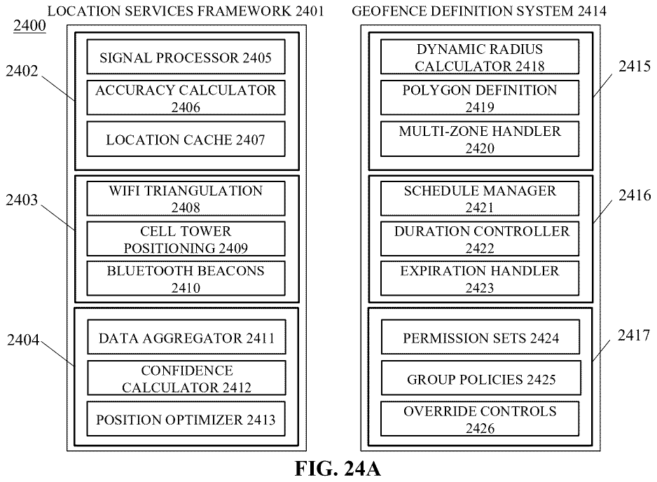

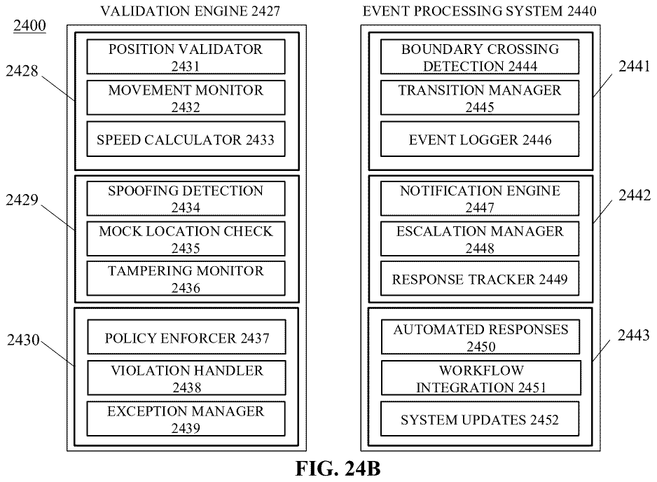

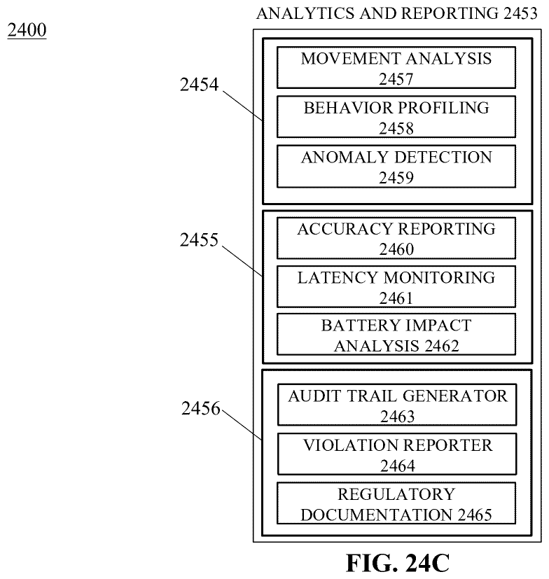

With reference to FIGS. 24A-24C, a geofencing and location validation system 2400 is disclosed. Geofencing and location validation system 2400 is configured to ensure secure and accurate ride group formation. Geofencing and location validation system 2400 comprises location services framework 2401, geofence definition system 2414, validation engine 2427, event processing system 2440, and analytics and reporting system 2453.

According to an embodiment, geofencing and location validation system 2400 may implement location validation (e.g., hybrid positioning systems, indoor positioning solutions, mesh network positioning, and satellite-based validation) and boundary definition (e.g., dynamic boundary adjustment, multi-zone implementation, time-based boundaries, and context-aware perimeters). Geofencing implementation may utilize hybrid positioning system (GPS+WiFi+Cell), dynamic geofence adjustment, 100-meter accuracy requirement, 30-second location update interval, and battery-optimized tracking algorithms.

Location services framework 2401 comprises GPS management system 2402, alternative location systems 2403, and location fusion engine 2404. GPS management system 2402 comprises signal processor 2405, accuracy calculator 2406, and location cache 2407. Alternative location systems 2403 comprises WiFi triangulation 2408, cell tower positioning 2409, and Bluetooth beacons 2410. Location fusion engine 2404 comprises data aggregator 2411, confidence calculator 2412, and position optimizer 2413.

Geofence definition system 2414 comprises boundary management system 2415, time-based controls 2416, and access rules engine 2417. Boundary management system 2415 comprises dynamic radius calculator 2418, polygon definition 2419, and multi-zone handler 2420. Time-based controls 2416 comprise schedule manager 2421, duration controller 2422, and expiration handler 2423. Access rules engine 2417 comprises permission sets 2424, group policies 2425, and override controls 2426.

Validation engine 2427 comprises real-time checks 2428, security verification 2429, and compliance engine 2430. Real-time checks 2428 comprise position validator 2431, movement monitor 2432, and speed calculator 2433. Security verification 2429 comprises spoofing detection 2434, mock location check 2435, and tampering monitor 2436. Compliance engine 2430 comprises policy enforcer 2437, violation handler 2438, and exception manager 2439.

Event processing system 2440 comprises entry/exit handling system 2441, alert generation system 2442, and action triggers 2443. Entry/exit handling system 2441 comprises boundary crossing detection 2444, transition manager 2445, and event logger 2446. Alert generation system 2442 comprises notification engine 2447, escalation manager 2448, and response tracker 2449. Alert generation system 2442 is configured to provide ride alerts, payment updates, and fraud warnings, providing a comprehensive real-time transaction framework. Action triggers 2443 comprise automated responses 2450, workflow integration 2451, and system updates 2452.

Analytics and reporting system 2453 comprises pattern recognition system 2454, performance metrics system 2455, and compliance reporting system 2456. Pattern recognition system 245 comprises movement analysis 2457, behavior profiling 2458, and anomaly detection 2459. Performance metrics system 2455 comprises accuracy reporting 2460, latency monitoring 2461, and battery impact analysis 2462. Compliance reporting system 2456 comprises audit trail generator 2463, violation reporter 2464, and regulatory documentation 2465.

Key features of geofencing and location validation system 2400 include multi-source location verification, dynamic geofence adjustment, real-time validation, spoofing prevention, battery optimization, privacy protection, and regulatory compliance. Special considerations include battery life optimization, offline operation modes, privacy protection, cross-platform compatibility, regulatory compliance, and error tolerance handling.

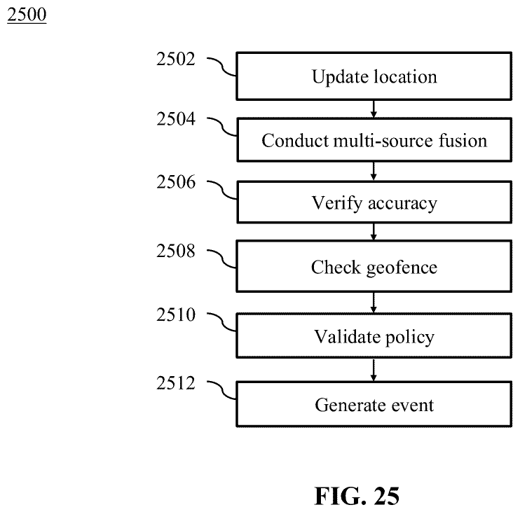

With reference to FIG. 25, a location validation process 2500 in accordance with some embodiments will now be described. The process of FIG. 25 comprises steps 2502 through 2512 and is suitable for use in system 100 but is more generally applicable to other types of carpooling systems.

At step 2502, a user's location is updated. At step 2504, a multi-source fusion is conducted. At step 2506, location accuracy is verified. At step 2508, a geofence is checked. At step 2510, a policy is validated. At step 2512, an event is generated.

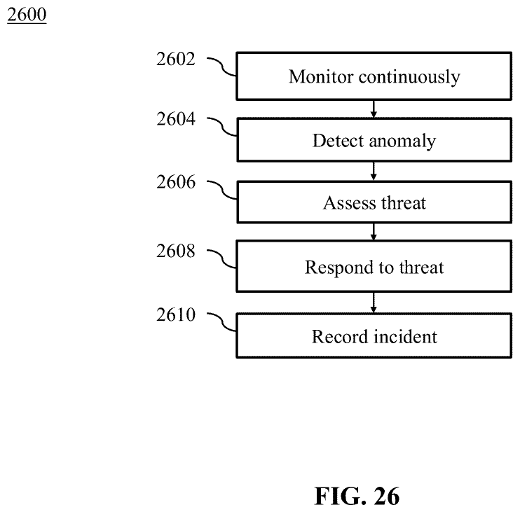

With reference to FIG. 26, a security monitoring process 2600 in accordance with some embodiments will now be described. The process of FIG. 26 comprises steps 2602 through 2610 and is suitable for use in system 100 but is more generally applicable to other types of carpooling systems.

At step 2602, security is continuously monitored. At step 2604, an anomaly is detected. At step 2606, the threat presented by the anomaly is assessed. At step 2608, the threat is responded to. At step 2610, the incident is recorded.

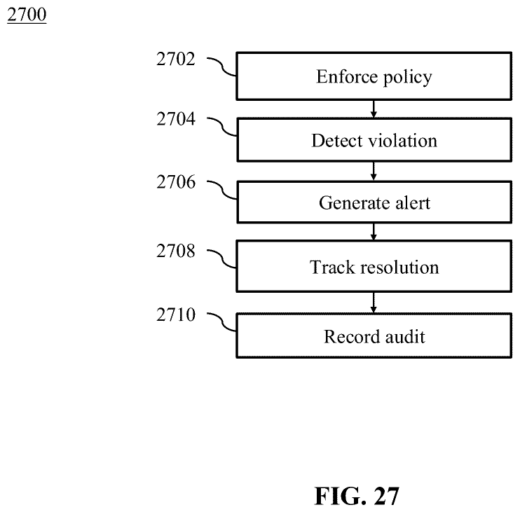

With reference to FIG. 27, a compliance management process 2700 in accordance with some embodiments will now be described. The process of FIG. 27 comprises steps 2702 through 2710 and is suitable for use in system 100 but is more generally applicable to other types of carpooling systems.

At step 2702, a corporate policy is enforced. At step 2704, a violation of the corporate policy is detected. At step 2706, an alert is generated. At step 2708, a resolution to the policy violation is tracked. At step 2710, an audit is recorded.

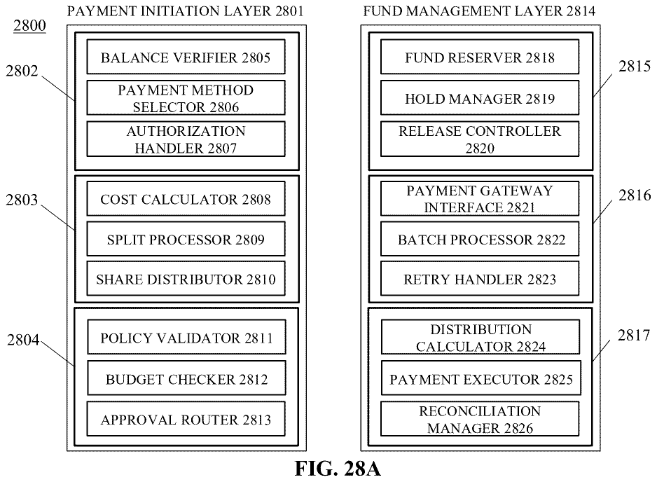

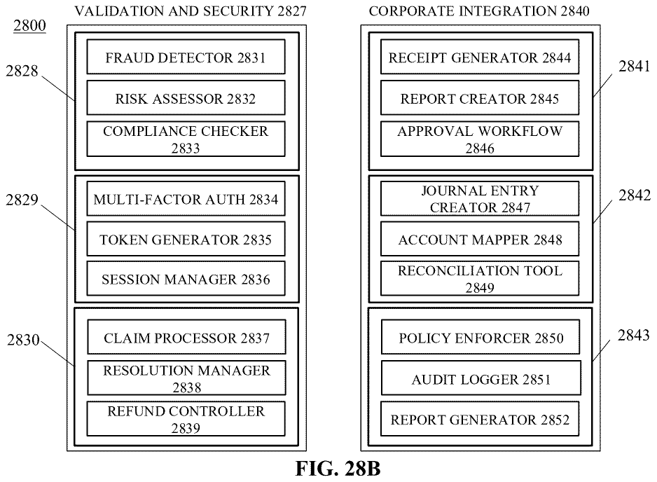

With reference to FIGS. 28A-28B, a multi-party payment framework 2800 is disclosed. Multi-party payment framework 2800 comprises payment initiation layer 2801, fund management layer 2814, validation and security layer 2827, and corporate integration layer 2840.

Payment initiation layer 2801 comprises user wallets 2802, group payment manager 2803, and corporate payment handler 2804. User wallets 2802 comprises balance verifier 2805, payment method selection system 2806, and authorization handler 2807. According to an embodiment, the payment system is configured to implement a multi-party wallet system (e.g., escrow functionality for ride payments, automated cost distribution, real-time balance management, and multiple payment method support) and transaction processing (e.g., Ride Creation→Fund Reservation→Ride Completion→Cost Calculation→Payment Distribution→Expense Report Generation).

System 100 is configured to operate at the user level, processing real-time multi-party transactions without speculative trading or contractual management. A multi-party escrow wallet automates ride cost distribution, ensuring fair and verifiable payments while preventing unauthorized transactions. System 100 dynamically assigns rides upon QR validation and ensures cost-splitting integrity through an encrypted ledger.

Group payment manager 2803 comprises cost calculator 2808, split processor 2809, and share distributor 2810. Group payment manager 2803 is configured to initiate payment. Corporate payment handler 2804 comprises policy validator 2811, budget checker 2812, and approval router 2813. Corporate payment handler 2804 is configured to validate policy and budget.

Fund management layer 2814 comprises escrow service 2815, transaction processor 2816, and settlement engine 2817. Escrow service 2815 comprises fund reservation system 2818, hold manager 2819, and release controller 2820. Escrow service 2815 is configured to reserve funds. Transaction processor 2816 comprises payment gateway interface 2821, batch processor 2822, and retry handler 2823. Transaction processor 2816 is configured to process payment. Settlement engine 2817 comprises distribution calculator 2824, payment executor 2825, and reconciliation manager 2826. Settlement engine 2817 is configured to execute payment.

Validation and security layer 2827 comprises payment verification service 2828, authorization service 2829, and dispute handler 2830. Payment verification service 2828 comprises fraud detector 2831, risk assessor 2832, and compliance checker 2833. Payment verification service 2828 is configured to check for fraud and risk. Authorization service 2829 comprises multi-factor authenticator 2834, token generator 2835, and session manager 2836. Authorization service 2829 is configured to validate multi-factor authentications. Authorization service 2829 is configured to approve or reject transactions. Dispute handler 2830 comprises claim processor 2837, resolution manager 2838, and refund controller 2839.

Corporate integration layer 2840 comprises expense processing system 2841, accounting interface 2842, and compliance monitor 2843. Expense processing system 2841 comprises receipt generator 2844, report creator 2845, and approval workflow engine 2846. Expense processing system 2841 is configured to generate a receipt and an expense report. Accounting interface 2842 comprises journal entry creator 2847, account mapper 2848, and reconciliation tool 2849. Accounting interface 2842 is configured to record transactions. Compliance monitor 2843 comprises policy enforcer 2850, audit logger 2851, and report generator 2852. Compliance monitor 2843 is configured for audits and reconciliation.

According to an embodiment, key features of multi-party payment framework 2800 include real-time payment processing, multi-party fund management, secure escrow handling, dynamic cost splitting, corporate policy enforcement, automated reconciliation, dispute resolution, and audit trail maintenance. Multi-party payment framework is configured to handle the following transaction states: pending authorization, funds reserved, processing, settled, disputed, reconciled, and expense reported.

Multi-party payment framework 2800 implements the following security measures: multi-factor authentication, fraud detection, risk scoring, compliance validation, and encryption protocols. Multi-party payment framework 2800 is configured to handle errors such as payment failures, authorization issues, network timeouts, policy violations, and dispute processes. Multi-party payment framework 2800 is configured to ensure transaction atomicity, data consistency, isolation of funds, durability of records, and complete audit trails.

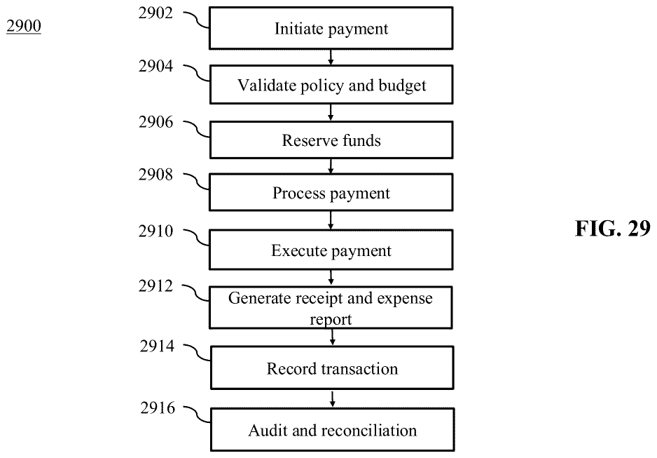

With reference to FIG. 29, a payment sequence in a multi-party payment process 2900 in accordance with some embodiments will now be described. The process of FIG. 29 comprises steps 2902 through 2916 and is suitable for use in system 100 but is more generally applicable to other types of carpooling systems.

At step 2902, group payment manager 2803 initiates payment. At step 2904, corporate payment handler 2804 validates policy and budget. At step 2906, escrow service 2815 reserves funds. At step 2908, transaction processor 2816 processes payment. At step 2910, settlement engine 2817 executes payment. At step 2912, expense processing system 2841 generates a receipt and expense report. At step 2914, accounting interface 2842 records the transaction. At step 2916, compliance monitor 2843 conducts audit and reconciliation.

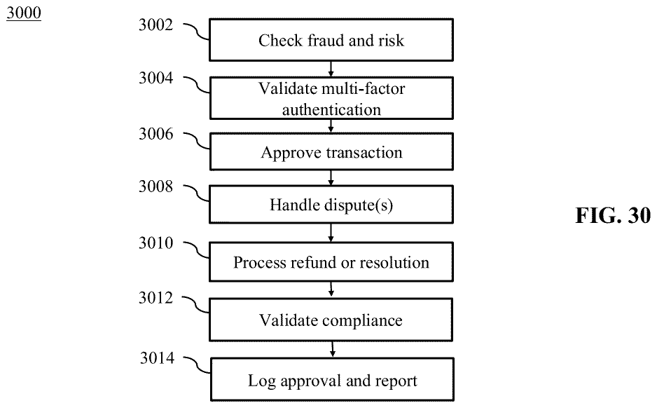

With reference to FIG. 30, a payment sequence in a multi-party payment process 3000 in accordance with some embodiments will now be described. The process of FIG. 30 comprises steps 3002 through 3014 and is suitable for use in system 100 but is more generally applicable to other types of carpooling systems. The process of FIG. 30 may be conducted in parallel with the process of FIG. 29.

At step 3002, payment verification service 2828 checks for fraud and risk. At step 3004, authorization service 2829 validates multi-factor authentication. At step 3006, transaction processor 2816 approves the transaction. According to an embodiment, if authorization service 2829 does not validate the multi-factor authentication, transaction processor 2816 rejects the transaction.

At step 3008, dispute handler 2830 handles disputes. At step 3010, user wallets 2802 processes a refund or resolution. At step 3012, compliance monitor 2843 validates compliance. At step 3014, accounting interface 2842 logs the approval and report.

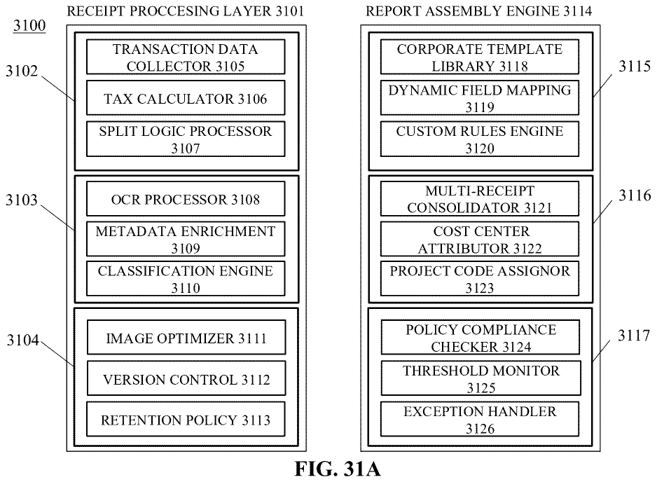

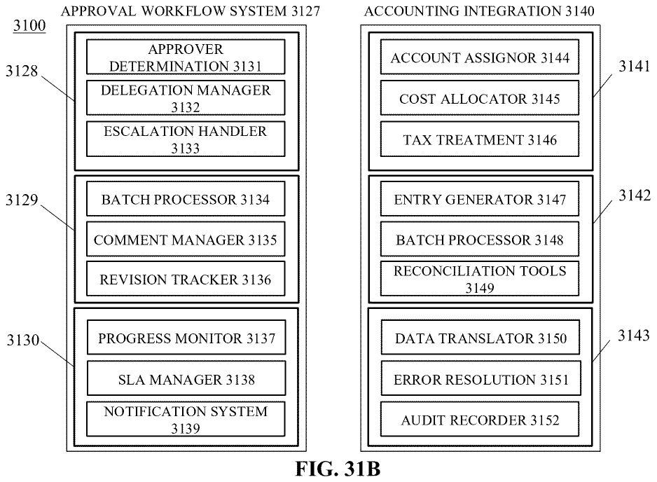

With reference to FIGS. 31A-31B, an expense report generation framework 3100 is disclosed. Expense report generation framework 3100 comprises receipt processing layer 3101, report assembly engine 3114, approval workflow system 3127, and accounting integration 3140.

Receipt processing layer 3101 comprises digital receipt generator 3102, receipt enhancer 3103, and storage manager 3104. Digital receipt generator 3102 comprises transaction data collector 3105, tax calculator 3106, and split logic processor 3107. Receipt enhancer 3103 comprises OCR processor 3108, metadata enrichment 3109, and classification engine 3110. Storage manager 3104 comprises image optimizer 3111, version control system 3112, and retention policy system 3113.

Report assembly engine 3114 comprises template manager 3115, data aggregator 3116, and validation service 3117. Template manager 3115 comprises corporate template library 3118, dynamic field mapping system 3119, and custom rules engine 3120. Data aggregator 3116 comprises multi-receipt consolidator 3121, cost center attributor 3122, and project code assignor 3123. Validation service 3117 comprises policy compliance checker 3124, threshold monitor 3125, and exception handler 3126.

Approval workflow system 3127 comprises routing engine 3128, review interface 3129, and status tracker 3130. Routing engine 3128 comprises approver determination system 3131, delegation manager 3132, and escalation handler 3133. Review interface 3129 comprises batch processor 3134, comment manager 3135, and revision tracker 3136. Status tracker 3130 comprises progress monitor 3137, SLA manger 3138, and notification system 3139.

Accounting integration 3140 comprises GL code mapper 3141, journal entry creator 3142, and system synchronizer 3143. GL code mapper 3141 comprises account assignor 3144, cost allocator 3145, and tax treatment system 3146. Journal entry creator 3142 comprises entry generator 3147, batch processor 3148, and reconciliation tools 3149. System synchronizer 3143 comprises data translator 3150, error resolution center 3151, and audit recorder 3152. Error resolution center 3151 is configured to handle and address errors such as missing information, policy violations, approval timeouts, system integration failures, and data synchronization issues.

Key features of expense report generation framework 3100 include automated receipt processing, smart data extraction, policy compliance checking, dynamic routing rules, real-time validation, exception handling, and system integration. Expense report generation framework 3100 is configured for special considerations such as multi-currency support, international tax handling, corporate policy compliance, regulatory requirements, and audit trail maintenance. Expense report generation framework 3100 is configured to provide real-time status tracking, exception notifications, progress monitoring, performance metrics, and compliance reporting.

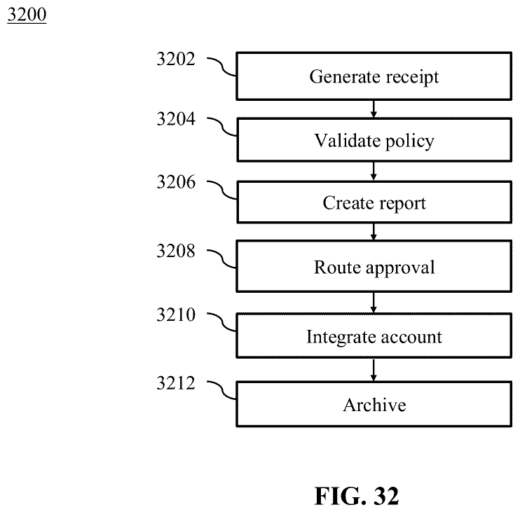

With reference to FIG. 32, an expense report generation process 3200 in accordance with some embodiments will now be described. The process of FIG. 32 comprises steps 3202 through 3212 and is suitable for use in system 100 but is more generally applicable to other types of carpooling systems.

At step 3202, receipt processing layer 3101 generates a receipt. In an embodiment, sub-steps of step 3202 may include collecting transaction data (by transaction data collector 3105), enhancement of the receipt (by OCR processor 3108, metadata enrichment system 3109, and classification engine 3110), and storage management (by image optimizer 3111 and version control system 3112). A parallel step to step 3202 may comprise contributing to digital receipt generation by tax calculator 3106 and to GL code mapping by tax treatment system 3146.

At steps 3204 and 3206, validation service 3117 validates the policy and report assembly engine 3114 creates a report, respectively. In an embodiment, sub-steps of steps 3204 and 3206 may include consolidating multiple receipts (by multi-receipt consolidator 3121) and contributing to validating the policy by policy compliance checker 3124. A parallel step to steps 3204 and 3206 may comprise contributing to validating the policy by threshold monitor 3125 and to routing approval by escalation handler 3133. A parallel step to steps 3204 and 3206 may comprise contributing to data aggregation by project code assignor 3123 and GL code mapping by cost allocator 3145.

At step 3208, approval workflow system 3127 routes approval using routing engine 3128. Approver determination system 3131 and batch processor 3134 may contribute to step 3208. At step 3210, accounting integration 3140 integrates the account utilizing account assignor 3144. At step 3212, journal entry creator 3142 and system synchronizer 3143 conduct archiving, wherein entry generator 3147, data translator 3150, and audit recorder 3152 contribute. Error resolution center 3151 may contribute to system synchronization and notification system 3139 may contribute to status tracking. SLA manager 3138 and progress monitor 3137 may further contribute to status tracking.

According to an embodiment, policy compliance checker 3124 may utilize exception handler 3126 if unable to verify the policy. Notification system 3139 may send a notification of the failed verification. Review interface 3129 may then engage in revision tracking (by revision tracker 3136), error resolution (by error resolution center 3151), and audit recording (by audit recorder 3152). Notification system 3139 may send a notification of the resolved error.

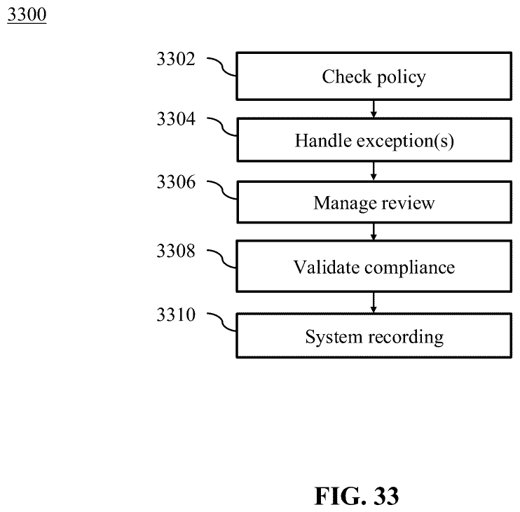

With reference to FIG. 33, a compliance process 3200 of an expense report generation framework in accordance with some embodiments will now be described. The process of FIG. 33 comprises steps 3302 through 3310 and is suitable for use in system 100 but is more generally applicable to other types of carpooling systems. The process of FIG. 33 may be conducted in parallel with the process of FIG. 32.

At step 3302, policy compliance checker 3124 checks the policy. At step 3304, exception handler 3126 handles exceptions. At step 3306, SLA manager 3138 manages review. At step 3308, policy compliance checker 3124 validates compliance. At step 3310, system synchronizer 3143 conducts system recording.

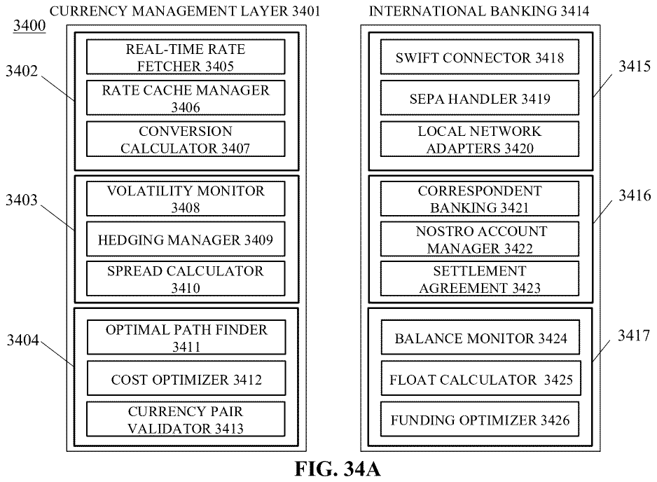

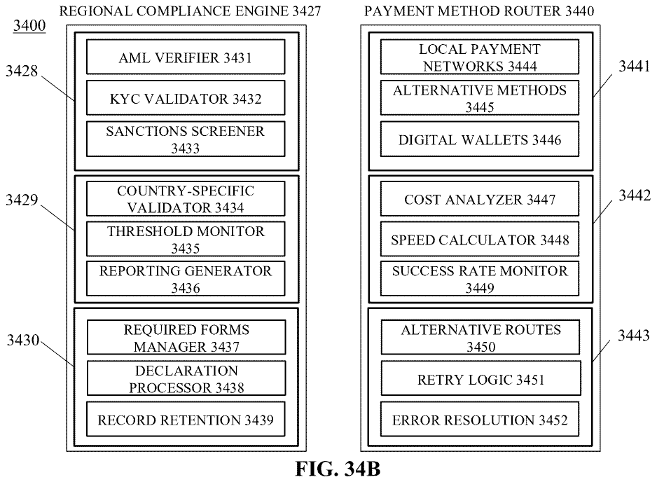

With reference to FIGS. 34A-34B, an international payment processing system 3400 is disclosed. International payment processing system 3400 comprises currency management layer 3401, international banking network 3414, regional compliance engine 3427, and payment method router 3440.

Currency management layer 3401 comprises exchange rate engine 3402, currency risk handler 3403, and settlement currency router 3404. Exchange rate engine 3402 comprises real-time rate fetcher 3405, rate cache manager 3406, and conversion calculator 3407. Currency risk handler 3403 comprises volatility monitor 3408, hedging manager 3409, and spread calculator 3410. Settlement currency router 3404 comprises optimal path finder 3411, cost optimizer 3412, and currency pair validator 3413.

International banking network 3414 comprises payment network integration 3415, bank relationship manager 3416, and liquidity manager 3417. Payment network integration 3415 comprises SWIFT connector 3418, SEPA handler 3419, and local network adapters 3420. Bank relationship manager 3416 comprises correspondent banking system 3421, Nostro account manager 3422, and settlement agreement handler 3423. Liquidity manager 3417 comprises balance monitor 3424, float calculator 3425, and funding optimizer 3426.

Regional compliance engine 3427 comprises regulatory framework 3428, regional rules processor 3429, and documentation handler 3430. Regulatory framework 3428 comprises AML verifier 3431, KYC validator 3432, and sanctions screener 3433. Regional rules processor 3429 comprises country-specific validator 3434, threshold monitor 3435, and reporting generator 3436. Documentation handler 3430 comprises required forms manager 3437, declaration processor 3438, and record retention system 3439.

Payment method router 3440 comprises regional gateway manager 3441, method optimizer 3442, and fallback manager 3443. Regional gateway manager 3441 comprises local payment networks 3444, alternative methods 3445, and digital wallets 3446. Method optimizer 3442 comprises cost analyzer 3447, speed calculator 3448, and success rate monitor 3449. Fallback manager 3443 comprises alternative routes 3450, retry logic 3451, and error resolution center 3452. Error resolution center 3452 is configured to address and handle errors including network failures, compliance violations, currency availability, settlement issues, and documentation gaps.

Key features of international payment processing system 3400 include multi-currency processing, real-time exchange rates, regulatory compliance, regional payment methods, cost optimization, risk management, and settlement tracking. International payment processing system 3400 is configured for special considerations such as currency conversion timing, exchange rate fluctuations, regional banking hours, local regulations, settlement delays, and documentation requirements. International payment processing system 3400 ensures regulatory compliance, cost efficiency, transaction transparency, settlement finality, and complete audit trails.

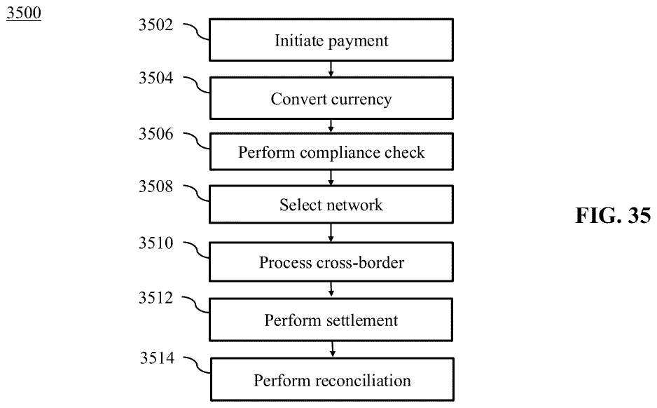

With reference to FIG. 35, an international payment process 3500 in accordance with some embodiments will now be described. The process of FIG. 35 comprises steps 3502 through 3514 and is suitable for use in system 100 but is more generally applicable to other types of carpooling systems.

At step 3502, payment initiation layer 2801 initiates payment. At step 3504, exchange rate engine 3402 converts currency. At step 3506, regional compliance engine 3427 performs a compliance check. At step 3508, international banking network 3414 selects a network. At step 3510, cross-border processing is conducted. At step 3512, settlement currency router 3404 conducts settlement. At step 3514, reconciliation is performed.

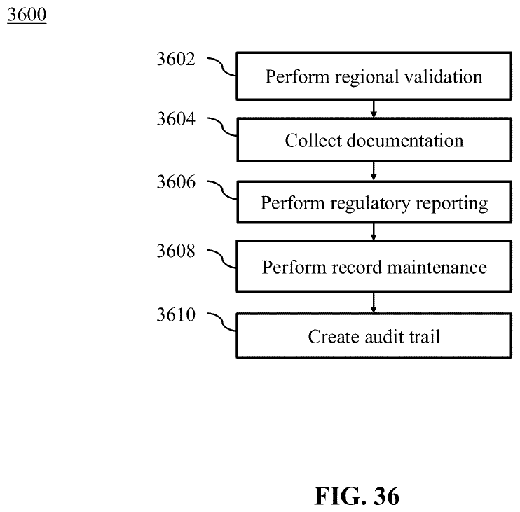

With reference to FIG. 36, an international payment compliance process 3600 in accordance with some embodiments will now be described. The process of FIG. 36 comprises steps 3602 through 3610 and is suitable for use in system 100 but is more generally applicable to other types of carpooling systems.

At step 3602, regional compliance engine 3427 performs regional validation. At step 3604, documentation handler 3430 collects documentation. At step 3606, reporting generator 3436 performs regulatory reporting. At step 3608, record retention system 3439 performs record maintenance. At step 3610, an audit trail is created.

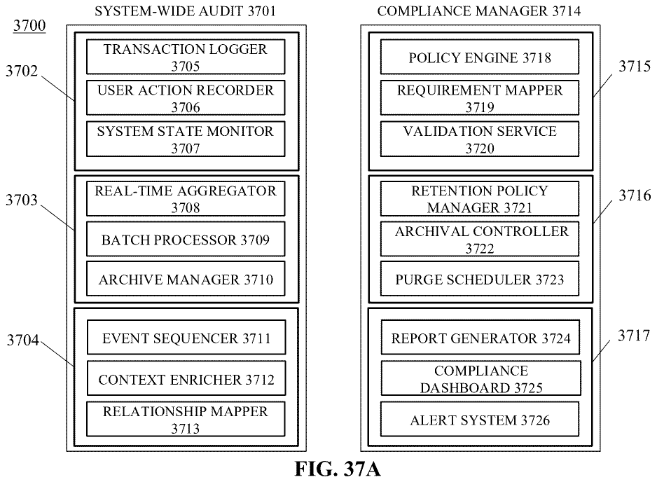

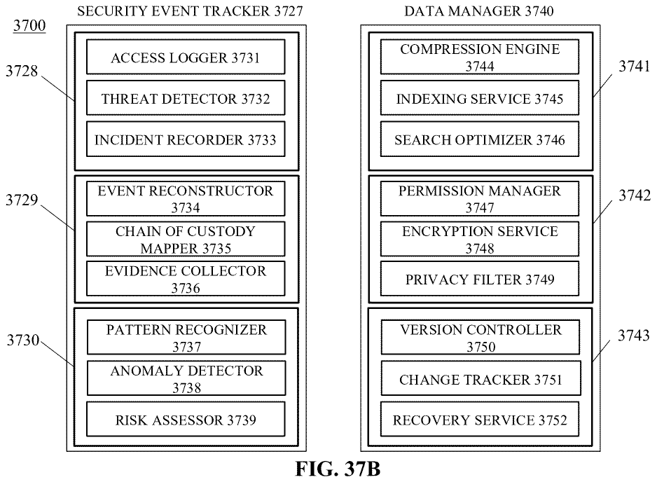

With reference to FIGS. 37A-37B, an audit trail and logging framework 3700 is disclosed. Audit trail and logging framework 3700 comprises system-wide audit architecture 3701, compliance manager 3714, security event tracker 3727, and data manager 3740.

System-wide audit architecture 3701 comprises event capture layer 3702, data collection framework 3703, and correlation engine 3704.

Event capture layer 3702 comprises transaction logger 3705, user action recorder 3706, and system state monitor 3707. Data collection framework 3703 comprises real-time aggregator 3708, batch processor 3709, and archive manager 3710. Correlation engine 3704 comprises event sequencer 3711, context enricher 3712, and relationship mapper 3713.

Compliance manager 3714 comprises regulatory framework 3715, record retainer 3716, and reporting engine 3717. Regulatory framework 3715 comprises policy engine 3718, requirement mapper 3719, and validation service 3720. Record retainer 3716 comprises retention policy manger 3721, archival controller 3722, and purge scheduler 3723. Reporting engine 3717 comprises report generator 3724, compliance dashboard 3725, and alert system 3726.

Security event tracker 3727 comprises security monitor 3728, forensic tools 3729, and analysis engine 3730. Security monitor 3728 comprises access logger 3731, threat detector 3732, and incident recorder 3733. Forensic tools 3729 comprise event reconstructor 3734, chain of custody mapper 3735, and evidence collector 3736. Analysis engine 3730 comprises pattern recognizer 3737, anomaly detector 3738, and risk assessor 3739.

Data manager 3740 comprises storage optimizer 3741, access controller 3742, and data lifecycle manger 3743. Storage optimizer 3741 comprises compression engine 3744, indexing service 3745, and search optimizer 3746. Access controller 3742 comprises permission manager 3747, encryption service 3748, and privacy filter 3749. Data lifecycle manger 3743 comprises version controller 3750, change tracker 3751, and recovery service 3752.

Audit trail and logging framework 3700 is configured to ensure complete traceability and compliance across all system 100 operations. Audit trail and logging framework 3700 is further configured to ensure data integrity, chain of custody, privacy protection, regulatory compliance, and system accountability. Key features of audit trail and logging framework 3700 include complete audit coverage, real-time event tracking, compliance monitoring, secure storage, automated reporting, data lifecycle management, and forensic capabilities. Audit trail and logging framework 3700 is configured for special considerations such as data privacy requirements, regulatory compliance, storage optimization, search capabilities, recovery procedures, and access controls. Audit trail and logging framework 3700 is further configured for error handling such as data corruption, storage failures, processing delays, compliance violations, and security incidents.

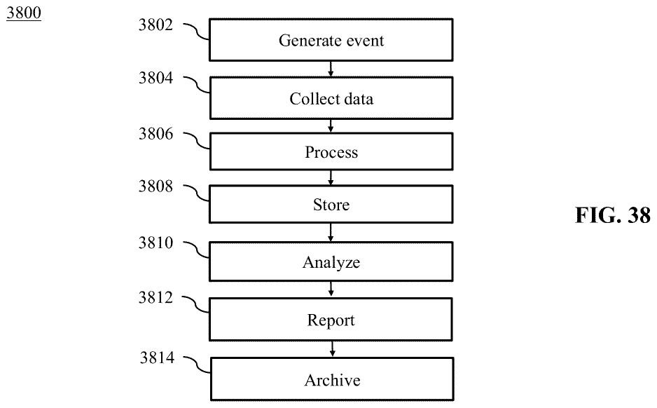

With reference to FIG. 38, an audit trail and logging process 3800 in accordance with some embodiments will now be described. The process of FIG. 38 comprises steps 3802 through 3814 and is suitable for use in system 100 but is more generally applicable to other types of carpooling systems.

At step 3802, an event is generated. At step 3804, data is collected. At step 3806, the data is processed. At step 3808, the data is stored. At step 3810, the data is analyzed. At step 3812, an audit report is made. At step 3814, the audit report is archived.

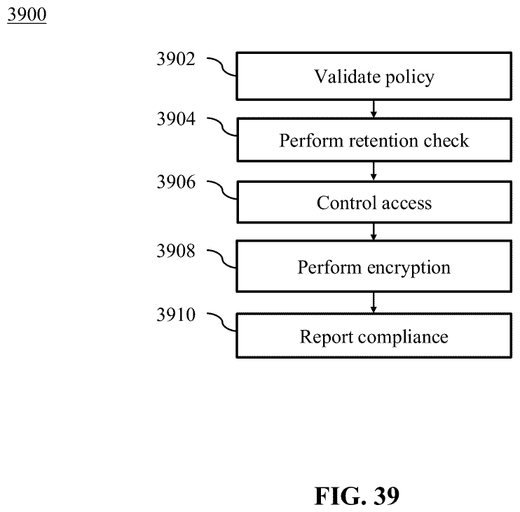

With reference to FIG. 39, a compliance process 3900 of an audit trail and logging framework in accordance with some embodiments will now be described. The process of FIG. 39 comprises steps 3902 through 3910 and is suitable for use in system 100 but is more generally applicable to other types of carpooling systems.

At step 3902, a policy is validated. At step 3904, a retention check is performed. At step 3906, access is controlled. At step 3908, encryption is performed. At step 3910, compliance is reported.

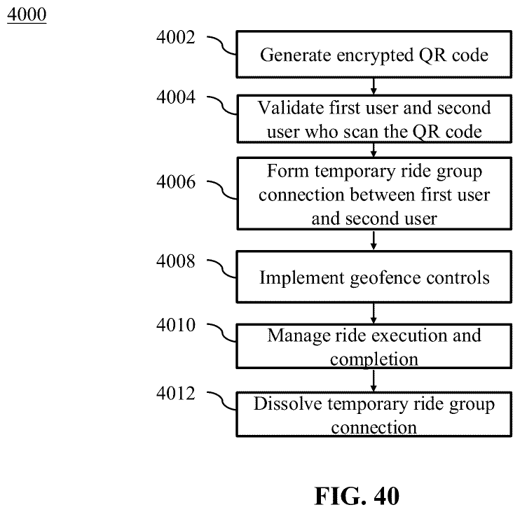

With reference to FIG. 40, a method for dynamic carpool formation 4000 in accordance with some embodiments will now be described. The process of FIG. 40 comprises steps 4002 through 4012 and is suitable for use in system 100 but is more generally applicable to other types of carpooling systems. The process of FIG. 40 may be performed by a processor comprising hardware.

At step 4002, a hybrid encryption system generates an encrypted QR code containing ride metadata. Ride metadata may comprise one or more of unique ride identifier, organizer identification, destination coordinates, temporal validity parameters, maximum user count, and ride-specific access controls. Step 4002 may comprise encrypting a payload containing ride details using a symmetric encryption algorithm, encrypting a symmetric key using an asymmetric encryption algorithm, and combining the encrypted payload and encrypted symmetric key into a QR code. The encrypted payload may comprise 1) a header section comprising one or more of version information, timestamp data, expiration parameters, and digital signatures, and 2) an encrypted payload section comprising one or more of ride details, access control parameters, and payment requirements.

At step 4004, a multi-factor authentication system validates a first user and a second user who scan the encrypted QR code. Step 4004 may comprise verifying authentication credentials of the first user and the second user, checking temporal validity of the encrypted QR code, validating location data of the first user and the second user against geofencing parameters, and confirming eligibility of the first user and the second user based on a presence of a temporary ride group connection.

At step 4006, system 100 forms a temporary ride group connection between the first user and the second user if the first user and the second user have been validated. At step 4008, system 100 implements geofencing controls for the first user and the second user. At step 4010, system 100 manages ride execution and completion through integration with third-party ride services (e.g., Uber® or Lyft®). Step 4010 may comprise automatically booking a ride service for the first user and the second user, providing a real-time status update to the first user and the second user, dynamically estimating a ride fare, tracking a location of the first user and the second user, and predicting an arrival time of the first user and the second user. At step 4012, system 100 dissolves the temporary ride group connection upon ride completion.

According to an embodiment, method 4000 may further comprise implementing a time-based expiration system wherein a temporal validity is established for the encrypted QR code. The encrypted QR code may be automatically invalidated upon one or more of exceeding the temporal validity, reaching a maximum user count, processing a ride cancellation, and detecting a security policy violation. Method 4000 may implement one or more security measures comprising preventing duplication of the encrypted QR code, detecting tampering attempts, logging validation attempts, maintaining security audit trails, and implementing rate limiting controls.

According to an embodiment, method 4000 may further comprise retrieving, from a user database, data for the first user and the second user. The retrieved data may be used for calculating a trust score for the first user and the second user. The trust score may be calculated based on a weighted formula combining one or more trust factors including a trust relationship frequency analysis, temporary ride group connection volatility, and historical verification irregularities. Method 4000 may further comprise determining that the calculated trust score exceeds a minimum threshold value, updating the temporary ride group connection to a temporary trust relationship between the first user and the second user if the calculated trust score exceeds the minimum threshold value, and automatically revoking the temporary trust relationship if the calculated trust score falls below the minimum threshold value.

In an embodiment, method 4000 may further comprise calculating, by a payment distribution engine, one or more individual shares of a ride cost, reserving, by the payment distribution engine, funds from a digital wallet of the first user and a digital wallet of the second user, and executing, by the payment distribution engine, automated payment distribution upon ride completion.

According to an embodiment, the hybrid encryption system may further comprise post-quantum cryptographic algorithms, including lattice-based encryption for symmetric key exchange, hash-based signatures for QR code validation, Learning with Errors (LWE) for key encapsulation mechanisms, and code-based encryption for long-term security of stored ride data.

According to an embodiment, the system may dynamically select encryption algorithms based on system resource constraints, network conditions, security policy compliance, and real-time threat detection results.

In an embodiment, a system for secure ride-sharing payment processing is disclosed. The system may comprise a multi-party wallet system with escrow functionality; a payment distribution engine that calculates individual shares of ride costs, reserves funds from participant wallets, and executes automated payment distribution upon ride completion; a dispute resolution mechanism for handling payment conflicts; and an expense report generation system for corporate ride expenses.

According to an embodiment, the multi-party wallet system may comprise individual digital wallets for each user, secure payment method storage, real-time balance tracking, automated fund reservation mechanisms, and integrated expense tracking. The payment distribution engine may be configured to support multiple cost-splitting algorithms, handle dynamic fare adjustments, process multi-currency transactions, manage partial payment scenarios, and integrate with corporate payment systems.

According to an embodiment, the dispute resolution mechanism may comprise automated conflict detection, multi-party evidence collection, configurable resolution workflows, automated refund processing, and audit trail maintenance. The system may further comprise an escrow system that temporarily holds participant funds, validates payment sources, manages failed transaction scenarios, implements automatic release triggers, and maintains transaction histories. Expense report generation may include automatic receipt creation, corporate policy compliance checking, multi-level approval routing, cost center allocation, and tax jurisdiction handling.

According to an embodiment, the system may further implement international payment support with multi-currency conversion, regional tax calculations, international banking integration, compliance documentation, and cross-border transaction management. The payment processing may include real-time payment validation, fraud detection mechanisms, automatic retry logic, payment method fallback, and transaction reconciliation. The system may further comprise integration capabilities with corporate accounting systems, expense management platforms, third-party payment processors, banking institutions, and tax reporting systems.

According to an embodiment, the multi-party wallet system may be configured to support blockchain-based payments comprising cryptocurrency wallets for Bitcoin, Ethereum, and stablecoins; smart contract-based escrow management; decentralized identity verification for payment authentication; and immutable ledger for transaction tracking and dispute resolution. The payment processing engine may be configured to integrate with central bank digital currencies (CBDCs), allowing automated compliance with financial regulations, direct settlement with national payment systems, multi-currency conversion and hedging mechanisms, and tokenized ride credits for seamless cross-border transactions.

In an embodiment, a method for temporary group formation and management is disclosed. The method may comprise generating time-sensitive access credentials via encrypted QR codes, implementing geofencing controls for participant validation, managing temporary trust relationships between participants, dissolving group associations upon ride completion, and maintaining audit trails of group activities.

According to an embodiment, generating time-sensitive access credentials may comprise creating unique encryption keys for each group, implementing time-based key rotation, embedding temporal validity parameters, generating dynamic access tokens, and maintaining key distribution logs. Geofencing controls may include real-time location validation, proximity-based access restrictions, dynamic boundary adjustments, location spoofing detection, and multi-point geofence support.

According to an embodiment, managing temporary trust relationships may comprise establishing trust scores between participants, implementing group-based permissions, managing temporary access levels, tracking interaction history, and automated trust revocation. Dissolving group associations may include secure deletion of shared encryption keys, revoking access permissions, archiving group interaction data, notifying all participants, and clearing temporary credentials.

According to an embodiment, maintaining audit trails may comprise logging all group activities, tracking access attempts, recording permission changes, documenting trust relationships, and storing validation results. The method may further implement security measures including real-time participant verification, multi-factor authentication, behavior anomaly detection, automated security alerts, and incident response tracking.

According to an embodiment, group management may include dynamic role assignment, hierarchical permission structures, temporary delegate appointment, group size management, and participant removal handling. The method may further comprise privacy controls such as data minimization protocols, selective information sharing, temporary data storage, privacy policy enforcement, and consent management systems. User authentication may comprise behavioral biometric validation, including keystroke dynamics analysis, gait recognition during QR code scanning, voice pattern verification for ride authentication, and motion-based authentication using mobile device sensors. Participant authentication may include continuous passive validation using device telemetry analysis for abnormal behavior detection, AI-driven behavioral profiling to detect ride hijacking attempts, and continuous geolocation validation against expected travel patterns.

In an embodiment, a system for corporate ride-sharing expense management is disclosed. The system may comprise an automated expense report generation engine, integration with corporate cost centers, a multi-level approval workflow system, international payment processing capabilities, and compliance monitoring and policy enforcement mechanisms.

According to an embodiment, the automated expense report generation engine may comprise real-time receipt capture and processing, automatic expense categorization, multi-party expense allocation, customizable report templates, and bulk processing capabilities. Corporate cost center integration may include automated cost allocation rules, project code mapping, department-based billing, and budget tracking mechanisms.

According to an embodiment, the approval workflow system may implement configurable approval chains, delegation management, threshold-based routing, automated reminder systems, and exception handling procedures. International payment processing may comprise multi-currency support, exchange rate management, international tax handling, cross-border compliance and regional payment methods.

According to an embodiment, compliance monitoring may include policy violation detection, automated compliance checks, regulatory requirement tracking, audit trail generation, and reporting violations. The system may further comprise integration capabilities with enterprise resource planning systems, accounting software, human resources systems, travel management platforms, and compliance monitoring tools. Policy enforcement may include real-time policy checking, automated approval routing, exception management, policy override tracking, and violation reporting.

According to an embodiment, the system may further implement reporting features including customizable dashboard creation, trend analysis tools. cost optimization reports, compliance monitoring, and audit preparation support. Fraud detection mechanisms may employ machine learning models trained on historical ride-sharing fraud patterns, anomalous payment behavior analysis, AI-based trust scoring of ride participants, and social graph analysis for trust propagation in group rides. Machine learning-based anomaly detection may be used to flag high-risk transactions before execution, predict fraudulent ride group formations, recommend risk mitigation actions for ride organizers, and dynamically adjust participant verification thresholds based on contextual factors.

The particular processing operations and other system functionality described in conjunction with the flow diagrams of FIGS. 3, 7-8, 10-15, 17-19, 21-23, 25-27, 29-30, 32-33, 35-36, and 38-40 are presented by way of illustrative example only and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to implement the disclosed embodiments.

Functionality such as that described in conjunction with the processes of FIGS. 3, 7-8, 10-15, 17-19, 21-23, 25-27, 29-30, 32-33, 35-36, and 38-40 may be implemented at least in part in the form of one or more software programs stored in memory and executed by a processor of a processing device such as a computer or server. As will be described herein, a memory or other storage device having executable program code of one or more software programs embodied therein is an example of what is more generally referred to herein as a “processor-readable storage medium.”

FIGS. 1 through 40 are conceptual illustrations allowing for an explanation of the disclosed embodiments of the invention. Notably, the figures and examples above are not meant to limit the scope of the invention to a single embodiment, as other embodiments are possible by way of interchange of some or all of the described or illustrated elements. Moreover, where certain elements of the disclosed embodiments can be partially or fully implemented using known components, only those portions of such known components that are necessary for an understanding of the disclosed embodiments are described, and detailed descriptions of other portions of such known components are omitted so as not to obscure the disclosed embodiments. In the present specification, an embodiment showing a singular component should not necessarily be limited to other embodiments including a plurality of the same component, and vice-versa, unless explicitly stated otherwise herein. Moreover, terms in the specification or claims are not intended to be ascribed an uncommon or special meaning unless explicitly set forth as such. Further, the disclosed embodiments encompass present and future known equivalents to the known components referred to herein by way of illustration.

It should be understood that the various aspects of the embodiments could be implemented in hardware, firmware, software, or combinations thereof. In such embodiments, the various components and/or steps would be implemented in hardware, firmware, and/or software to perform the functions of the disclosed embodiments. That is, the same piece or different pieces of hardware, firmware, or module of software could perform one or more of the illustrated blocks (e.g., components or steps). In software implementations, computer software (e.g., programs or other instructions) and/or data is stored on a machine-readable medium as part of a computer program product and is loaded into a computer system or other device or machine via a removable storage drive, hard drive, or communications interface. Computer programs (also called computer control logic or computer-readable program code) are stored in a main and/or secondary memory, and executed by one or more processors (controllers, or the like) to cause the one or more processors to perform the functions of the invention as described herein. In this document, the terms “machine readable medium,” “computer-readable medium,” “computer program medium,” and “computer usable medium” are used to generally refer to media such as a random access memory (RAM); a read only memory (ROM); a removable storage unit (e.g., a magnetic or optical disc, flash memory device, or the like); a hard disk; or the like.

The foregoing description will so fully reveal the general nature of the disclosed embodiments that others can, by applying knowledge within the skill of the relevant art(s) (including the contents of the documents cited and incorporated by reference herein), readily modify and/or adapt for various applications such specific embodiments, without undue experimentation, without departing from the general concept of the disclosed embodiments. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

### EXAMPLES

The following examples illustrate the flexibility of system 100 in handling different use cases while maintaining security, compliance, and efficiency. The implementations showcase the ability of system 100 to adapt to specific organizational needs while preserving core functionality.

### Example 1

### Corporate Event Implementation

A large technology company implements system 100 for their annual conference with 5,000 attendees:
QR codes are generated for different hotel-venue routes
Employees scan codes to join specific ride groups
Corporate payment integration handles all expenses
Automated expense reporting to cost centers
Real-time tracking of all active rides
Compliance with corporate travel policies

Implementation highlights include:
Integration with corporate SSO
Automated cost allocation to departments
Bulk QR code generation for multiple routes
Real-time expense tracking and reporting
Group size optimization for vehicle capacity

### Example 2

### University Campus Implementation

A university deploys the system for student transportation between campuses:
Student ID integration for authentication
Geofenced pickup/dropoff points
Scheduled and on-demand ride groups
Integration with student payment systems
Safety features for after-hours rides

Technical features include:
Integration with university authentication
Campus map-based geofencing
Scheduled ride group formation
Student budget management
Emergency response integration

### Example 3

### International Travel Implementation

A multinational corporation implements the system for employee travel across countries:
Cross-border payment handling
Multi-currency support
International tax compliance
Country-specific ride service integration
Global expense management

Key components include:
Currency conversion automation
Regional compliance handling
International receipt generation
Cross-border expense allocation
Multi-language support

### Example 4

### Multi-Party Expense Splitting

A business consulting team implements the system for client visit transportation:
Mixed payment sources (corporate/personal)
Complex cost allocation rules
Multi-level approval workflows
Client billing integration
Detailed expense tracking

Implementation details include:
Hybrid payment processing
Automated cost distribution
Client-specific expense policies
Multi-party approval routing
Integrated client billing

1. Non-transitory computer-readable media comprising program code that when executed by a programmable processor in a computerized device causes execution by the processor of a method for dynamic carpool formation, the computer readable media comprising:
computer program code for generating, using a hybrid encryption system, an encrypted Quick Response (“QR”) code containing ride metadata;
computer program code for validating, using a multi-factor authentication system, a first user and a second user who scan the encrypted QR code by verifying authentication credentials of the first user and the second user, checking temporal validity of the encrypted QR code, validating location data of the first user and the second user against geofencing parameters, and confirming eligibility of the first user and the second user for a temporary ride group connection;
computer program code for forming a temporary ride group connection between the first user and the second user if the first user and the second user have been validated; and
computer program code for managing ride execution and completion through API integration with third-party ride services.

2. The non-transitory computer-readable media of claim 1, wherein generating, using a hybrid encryption system, the encrypted QR code comprises:
encrypting a payload containing ride details using a symmetric encryption algorithm;
encrypting a symmetric key using an asymmetric encryption algorithm; and
combining the encrypted payload and encrypted symmetric key into a QR code.

3. The non-transitory computer-readable media of claim 2, wherein the encrypted payload comprises:
a header section comprising one or more of version information, timestamp data, expiration parameters, and digital signatures; and
an encrypted payload section comprising one or more of ride details, access control parameters, and payment requirements.

4. The non-transitory computer-readable media of claim 1, wherein the ride metadata comprises one or more of a unique ride identifier, organizer identification, destination coordinates, temporal validity parameters, maximum user count, and ride-specific access controls.

5. (canceled)

6. The non-transitory computer-readable media of claim 1 further comprising computer program code for:
implementing a time-based expiration system wherein a temporal validity is established for the encrypted QR code; and
automatically invalidating the encrypted QR code upon one or more of exceeding the temporal validity, reaching a maximum user count, processing a ride cancellation, and detecting a security policy violation.

7. The non-transitory computer-readable media of claim 1 further comprising computer program code for implementing one or more security measures comprising preventing duplication of the encrypted QR code, detecting tampering attempts, logging validation attempts, maintaining security audit trails, and implementing rate limiting controls.

8. The non-transitory computer-readable media of claim 1, wherein computer program code for managing ride execution comprises:
computer program code for automatically booking a ride service for the first user and the second user;
computer program code for providing a real-time status update to the first user and the second user;
computer program code for dynamically estimating a ride fare;
computer program code for tracking a location of the first user and the second user; and
computer program code for predicting an arrival time of the first user and the second user.

9. The non-transitory computer-readable media of claim 1 further comprising computer program code for:
implementing geofencing controls for the first user and the second user;
managing temporary trust relationships between the first user and the second user;
dissolving the temporary ride group connection upon ride completion; and
maintaining audit trails of the temporary ride group connection.

10. The non-transitory computer-readable media of claim 1 further comprising computer code for:
retrieving, from a user database, data for the first user and the second user;
calculating a trust score for the first user and the second user using the data, the trust score being calculated based on a weighted formula combining one or more trust factors;
determining that the calculated trust score exceeds a minimum threshold value;
updating the temporary ride group connection to a temporary trust relationship between the first user and the second user if the calculated trust score exceeds the minimum threshold value; and
automatically revoking the temporary trust relationship if the calculated trust score falls below the minimum threshold value.

11. The non-transitory computer-readable media of claim 1 further comprising computer code for:
calculating, by a payment distribution engine, one or more individual shares of a ride cost;
reserving, by the payment distribution engine, funds from a digital wallet of the first user and a digital wallet of the second user; and
executing, by the payment distribution engine, automated payment distribution upon ride completion.

12. A method for dynamic carpool formation, the method performed by at least one processor comprising hardware and executing program code stored on a computer-readable media, the method comprising:
generating, using a hybrid encryption system, an encrypted Quick Response (“QR”) code containing ride metadata;
validating, using a multi-factor authentication system, a first user and a second user who scan the encrypted QR code;
forming a temporary ride group connection between the first user and the second user if the first user and the second user have been validated;
implementing geofencing controls for the first user and the second user;
managing ride execution and completion through API integration with third-party ride services; and
dissolving the temporary ride group connection upon ride completion.

13. The method of claim 12, wherein generating, using a hybrid encryption system, the encrypted QR code comprises:
encrypting a payload containing ride details using a symmetric encryption algorithm;
encrypting a symmetric key using an asymmetric encryption algorithm; and
combining the encrypted payload and encrypted symmetric key into a QR code.

14. The method of claim 13, wherein the encrypted payload comprises:
a header section comprising one or more of version information, timestamp data, expiration parameters, and digital signatures; and
an encrypted payload section comprising one or more of ride details, access control parameters, and payment requirements.

15. The method of claim 12, wherein the ride metadata comprises one or more of a unique ride identifier, organizer identification, destination coordinates, temporal validity parameters, maximum user count, and ride-specific access controls.

16. The method of claim 12, wherein validating, using a multi-factor authentication system, a first user and a second user comprises:
verifying authentication credentials of the first user and the second user;
checking temporal validity of the encrypted QR code;
validating location data of the first user and the second user against geofencing parameters; and
confirming eligibility of the first user and the second user based on a presence of a temporary ride group connection.

17. The method of claim 12 further comprising:
implementing a time-based expiration system wherein a temporal validity is established for the encrypted QR code; and
automatically invalidating the encrypted QR code upon one or more of exceeding the temporal validity, reaching a maximum user count, processing a ride cancellation, and detecting a security policy violation.

18. The method of claim 12 further comprising implementing one or more security measures comprising preventing duplication of the encrypted QR code, detecting tampering attempts, logging validation attempts, maintaining security audit trails, and implementing rate limiting controls.

19. The method of claim 12, wherein managing ride execution comprises:
automatically booking a ride service for the first user and the second user;
providing a real-time status update to the first user and the second user;
dynamically estimating a ride fare;
tracking a location of the first user and the second user; and
predicting an arrival time of the first user and the second user.

20. The method of claim 12, the method further comprising:
retrieving, from a user database, data for the first user and the second user;
calculating a trust score for the first user and the second user using the retrieved data, the trust score being calculated based on a weighted formula combining one or more trust factors;
determining that the calculated trust score exceeds a minimum threshold value;
updating the temporary ride group connection to a temporary trust relationship between the first user and the second user if the calculated trust score exceeds the minimum threshold value; and
automatically revoking the temporary trust relationship if the calculated trust score falls below the minimum threshold value.

21. The method of claim 20, wherein the one or more trust factors comprise a trust relationship frequency analysis, temporary ride group connection volatility, and historical verification irregularities.

22. The method of claim 12, the method further comprising:
calculating, by a payment distribution engine, one or more individual shares of a ride cost;
reserving, by the payment distribution engine, funds from a digital wallet of the first user and a digital wallet of the second user; and
executing, by the payment distribution engine, automated payment distribution upon ride completion.

23. Non-transitory computer-readable media comprising program code that when executed by a programmable processor in a computerized device causes execution by the processor of a method for dynamic carpool formation, the computer readable media comprising:
computer program code for generating, using a hybrid encryption system, an encrypted Quick Response (“QR”) code containing ride metadata;
computer program code for validating, using a multi-factor authentication system, a first user and a second user who scan the encrypted QR code;
computer program code for forming a temporary ride group connection between the first user and the second user if the first user and the second user have been validated; and
computer program code for managing ride execution and completion through API integration with third-party ride services, the computer program code for managing ride execution comprising:
computer program code for automatically booking a ride service for the first user and the second user;
computer program code for providing a real-time status update to the first user and the second user;
computer program code for dynamically estimating a ride fare;
computer program code for tracking a location of the first user and the second user; and
computer program code for predicting an arrival time of the first user and the second user.

24. The non-transitory computer-readable media of claim 23, further comprising computer program code for:
implementing geofencing controls for the first user and the second user;
managing temporary trust relationships between the first user and the second user;
dissolving the temporary ride group connection upon ride completion; and
maintaining audit trails of the temporary ride group connection.

25. The non-transitory computer-readable media of claim 23 further comprising computer code for:
retrieving, from a user database, data for the first user and the second user;
calculating a trust score for the first user and the second user using the data, the trust score being calculated based on a weighted formula combining one or more trust factors;
determining that the calculated trust score exceeds a minimum threshold value;
updating the temporary ride group connection to a temporary trust relationship between the first user and the second user if the calculated trust score exceeds the minimum threshold value; and
automatically revoking the temporary trust relationship if the calculated trust score falls below the minimum threshold value.

26. The non-transitory computer-readable media of claim 23 further comprising computer code for:
calculating, by a payment distribution engine, one or more individual shares of a ride cost;
reserving, by the payment distribution engine, funds from a digital wallet of the first user and a digital wallet of the second user; and
executing, by the payment distribution engine, automated payment distribution upon ride completion.

27. The non-transitory computer-readable media of claim 23 further comprising computer program code for:
implementing a time-based expiration system wherein a temporal validity is established for the encrypted QR code; and
automatically invalidating the encrypted QR code upon one or more of exceeding the temporal validity, reaching a maximum user count, processing a ride cancellation, and detecting a security policy violation.

28. The non-transitory computer-readable media of claim 23, wherein generating, using a hybrid encryption system, the encrypted QR code comprises:
encrypting a payload containing ride details using a symmetric encryption algorithm, the encrypted payload comprising a header section comprising one or more of version information, timestamp data, expiration parameters, and digital signatures and an encrypted payload section comprising one or more of ride details, access control parameters, and payment requirements;
encrypting a symmetric key using an asymmetric encryption algorithm; and
combining the encrypted payload and encrypted symmetric key into a QR code.

29. Non-transitory computer-readable media comprising program code that when executed by a programmable processor in a computerized device causes execution by the processor of a method for dynamic carpool formation, the computer readable media comprising:
computer program code for generating, using a hybrid encryption system, an encrypted Quick Response (“QR”) code containing ride metadata;
computer program code for validating, using a multi-factor authentication system, a first user and a second user who scan the encrypted QR code;
computer program code for forming a temporary ride group connection between the first user and the second user if the first user and the second user have been validated;
computer program code for managing ride execution and completion through API integration with third-party ride services;
computer program code for implementing geofencing controls for the first user and the second user;
computer program code for managing temporary trust relationships between the first user and the second user;
computer program code for dissolving the temporary ride group connection upon ride completion; and
computer program code for maintaining audit trails of the temporary ride group connection.

30. The non-transitory computer-readable media of claim 29 further comprising computer code for:
retrieving, from a user database, data for the first user and the second user;
calculating a trust score for the first user and the second user using the data, the trust score being calculated based on a weighted formula combining one or more trust factors;
determining that the calculated trust score exceeds a minimum threshold value;
updating the temporary ride group connection to a temporary trust relationship between the first user and the second user if the calculated trust score exceeds the minimum threshold value; and
automatically revoking the temporary trust relationship if the calculated trust score falls below the minimum threshold value.

31. The non-transitory computer-readable media of claim 29 further comprising computer code for:
calculating, by a payment distribution engine, one or more individual shares of a ride cost;
reserving, by the payment distribution engine, funds from a digital wallet of the first user and a digital wallet of the second user; and
executing, by the payment distribution engine, automated payment distribution upon ride completion.
